(19) United States
(12) Patent Application Publication
(10) Pub. No.: US 2011/0159306 A1
(43) Pub. Date: Jun. 30, 2011

(54) ADHESION TO METAL SURFACES WITH BLOCK COPOLYMERS OBTAINED USING RAFT

(76) Inventors: Michael Arnoldus Jacobus Schellekens, Waalwijik (NL); Tijs Nabuurs, Waalwijik (NL); John Geurts, Waalwijik (NL); Gerardus Cornelis Overbeek, Waalwijik (NL)

(21) Appl. No.: 13/001,940

(22) PCT Filed: Jun. 30, 2009
(86) PCT No.: PCT/EP2009/058159

§ 371 Date: Mar. 18, 2011

(30) Foreign Application Priority Data
Jun. 30, 2008 (EP) 08159342.8

(51) Int. Cl. B32B 15/08; B05D 3/00; C09D 153/00

(52) U.S. Cl. 428/461; 427/388.4; 524/460

(57) ABSTRACT

An aqueous, metal, coating composition (and process for obtaining it) comprising a block copolymer and a polymer P; wherein the block copolymer comprises at least blocks [A]ₓ[B]_{y}, where at least block [A] is obtained by a controlled radical polymerisation of at least one ethylenically unsaturated monomer via a reversible addition-fragmentation chain transfer (RAFT) mechanism in solution in the presence of a control agent and a source of free radicals; and where (a) block [A] comprises (i) 0 to 80 mol % of metal adhering ethylenically unsaturated monomers; (ii) 0 to 100 mol % of water dispersible ethylenically unsaturated monomers; (iii) 0 to 70 mol % of C₁ to C₃₀ hydrocarbo (meth)acrylate and/or styrenic monomers; (iv) 0 to 35 mol % of ethylenically unsaturated monomer different from i), ii)+iii); where the amount of at least one of i), ii), iii)+iv) is >0 mol %; block [A] has a Hansch parameter <1.5; and an average degree of polymerisation x, (x=3 to 80); (b) block [B] comprises: i) 0 to 50 mol % of metal adhering ethylenically unsaturated monomers; ii) 0 to 15 mol % of water dispersible ethylenically unsaturated monomers; iii) 20 to 100 mol % of C₁ to C₃₀ hydrocarbo (meth)acrylate and/or styrenic monomers; iv) 0 to 35 mol % of ethylenically unsaturated monomers units different from those from i), ii)+iii); where block [B] has a Hansch parameter ≧1.5; and block [B] an average degree of polymerisation y (y≧10 and >x); and (c) polymer P is obtained by an emulsion polymerisation process in the presence of the block copolymer [A][B] and comprises: i) 0 to 5 wt % of metal adhering ethylenically unsaturated monomers; ii) 0 to 15 wt % of water dispersible ethylenically unsaturated monomers; iii) 50 to 100 wt % C₁ to C₃₀ hydrocarbo (meth)acrylate and/or styrenic monomers; and iv) 0 to 35% by weight of ethylenically unsaturated monomers units different from those from i), ii)+iii).

This invention relates to an aqueous coating composition comprising a block copolymer, a polymer for improved adhesion to metal surfaces and processes from preparing them.

The corrosion of metals is an electrochemical process that degrades a metal surface. In an effort to prevent corrosion, polymer-based coatings have traditionally been applied to metal surfaces.

Adhesion of polymer coatings to a metal surface is promoted by the interactions between the polymer and groups (such as oxide or hydroxide) on the metal surface. Functional groups that are capable of forming interactions with a metal surface include: acids (such as phosphonic acids, sulphonic acids and carboxylic acids), anhydrides, amines, amides, silanes, urethane groups and ureido groups.

The process of corrosion begins when water and oxygen permeate through the polymer coating and displace some of the adsorbed groups of the coating from the metal surface. Accordingly, adhesion, especially wet adhesion, is important in achieving effective corrosion protection. Adequate wet adhesion is achieved when the adsorbed layer of the coating will not be desorbed from the metal surface when water penetrates the polymer film and approaches the interface between the coating and the metal surface.

It is well understood that good dry and wet adhesion to metal substrates is generally hard to achieve especially for waterborne coatings. The incorporation of good metal adhering monomers such as strongly acidic monomers is well known in the art. For example U.S. Pat. No. 6,756,495 describes phosphorous containing monomers such as phosphate esters of alkyl (meth)acrylates (e.g. phosphoethyl methacrylate). The use of anhydride or acetoacetoxy functional monomers (like maleic anhydride and acetoacetoxyethyl methacrylate) are also known to improve adhesion to metals (e.g. from U.S. Pat. No. 4,684,576 and US 2003-0134973).

However, the intrinsically hydrophilic nature of these adhesion promoting monomers is disadvantageous. The amounts of hydrophilic monomer typically used to adhere to metals, may still not produce good wet adhesion as the polymer/metal interface may weaken under humid conditions.

Furthermore, when hydrophilic adhesion promoting vinyl monomers are incorporated in an aqueous vinyl polymer prepared by emulsion polymerisation, these monomers tend to distribute inhomogeneously over the polymeric backbone. This reduces their efficiency as adhesion promoters. For example blocks of hydrophilic monomers may be formed, weaking the polymer metal interface when wet thus decreasing wet adhesion.

It is also believed that excessive polymerisation of acidic vinyl monomers in the aqueous phase will give “pitting corrosion”. Pitting corrosion is localised corrosion that leads to the creation of small holes in the metal. Pitting corrosion arises when there is a lack of oxygen around a small area which becomes anodic while the surrounding area with excess oxygen becomes cathodic, leading to very localized galvanic corrosion. Pitting is more dangerous than damage from uniform corrosion because it is more difficult to detect and design against. Metals which are susceptible to pitting corrosion (as a result of anionic attack) include metals such as aluminum, nickel, iron, chromium, and alloys containing one or more of these metals such as stainless steels.

It is therefore desirable for a vinyl based polymeric system to combine good adhesion on metal in dry as well as wet conditions.

It is also desirable to provide a waterborne polymer system that will give a good anti-corrosion behaviour.

U.S. Pat. No. 6,756,459 discloses a binder composition for aqueous coatings that exhibit high gloss and superior corrosion resistance when applied to metal substrates comprising an aqueous emulsion copolymer, the copolymer including as polymerised units, at least one ethylenically unsaturated monomer and an ethylenically unsaturated strong acid monomer, such as phosphorus containing monomers, particularly phosphoethyl methacrylate; or salts thereof.

EP 0272022 discloses non-aqueous polymeric dispersion compositions comprising a dispersion-polymerised copolymer of ethylenically unsaturated monomer(s) containing copolymerised therein from 0.5 to 10% by weight of said copolymer, of one or more adhesion promoter(s) having the chemical formula: CH₂═CHC(O)(OCH₂CH₂C(O))_{(1 to 6)}OH which are suitable for application to metallic substrates.

US2003-0134973 discloses a latex composition containing an acetoacetoxy functional polymer which is the emulsion polymerisation product of: (i) about 0.5 to about 30% by weight of at least one acetoacetoxy functional monomer; (ii) about 0.3 to about 6% by weight of at least one carboxylic acid functional vinyl monomer; (iii) about 60 to about 99% by weight of at least one non-acid, non-acetoacetoxy vinyl monomer. These latex compositions are useful in water-based coating compositions for metal surfaces and provide anti-corrosive and solvent-resistant properties to the coating compositions.

A problem often encountered in the preparation of conventional waterborne copolymers is that the level of control over the polymer chain architecture and chain composition is insufficient to attain the desired final application properties. For example, for metal coating systems it may be desirable to have an adhesion promoting functionality in only one segment of a polymer and to have a different functionality in another segment of the polymer, such as for example a pigment wetting functionality. Often a combination of good adhesion, good anticorrosion and good pigment wetting is desired. Additional properties may also be desired such as mechanical properties and low water-sensitivity.

Particular controlled radical polymerisation techniques such as nitroxide mediated polymerisation (NMP), atom transfer radical polymerisation (ATRP), and degenerative transfer techniques such as reversible addition-fragmentation chain transfer (RAFT) polymerisation have been investigated as means to control polymer chain composition and architecture.

WO03/055919 discloses a method for preparing an aqueous dispersion of polymer particles comprising preparing a dispersion having a continuous aqueous phase, a dispersed organic phase comprising one or more ethylenically unsaturated monomers, and an amphiphilic RAFT agent as a stabiliser for said organic phase, and polymerising said one or more ethylenically unsaturated monomers under the control of said amphiphilic RAFT agent to form said aqueous dispersion of polymer particles.

US2005-0119386 discloses the use of a block copolymer having at least one block that comprises phosphate and/or phosphonate functions, as an additive for film-forming compositions, such as paint, latex or mastic which is optionally siliconised in order to ensure or promote the adhesion of the compositions on a metallic surface or to protect said metallic surface against corrosion.

US2005-0181225 discloses the use of a block copolymer having at least one block that comprises phosphate and/or phosphonate functions in order to produce a deposit on a metallic surface, such as a steel or aluminium surface, which can be used, for example, to improve the effectiveness of the subsequent application of a film-forming composition on the thus altered surface or to protect the metallic surface against corrosion.

US2007-0015863 discloses a block polymer composed of a polymer block (A) mainly constituted by a constitutional unit derived from an olefin monomer and a polymer block (B) constituted by a constitutional unit derived from a vinyl monomer (b1) having a carboxyl group, a carboxylic anhydride group or a sulfonic group and a constitutional unit derived from another vinyl monomer (b2) copolymerisable with the vinyl monomer (b1). The content of the basic component is 0.05 equiv or more of the carboxyl group, carboxylic anhydride group or sulfonic group, each contained in the unit derived from the vinyl monomer (b1).

WO 2006-037161 describes aqueous compositions comprising a poly (acrylamide)-block-poly(butyl acrylate) polymer obtained by a RAFT polymerisation. These polymers are prepared in the presence of pigment particles (such as TiO₂) and are use to encapsulate these metallic particles. This document does not teach that these polymers may be used as a component (e.g. as a binders) in a composition designed to adhere to large metal surfaces.

U.S. Pat. No. 6,503,975 describes aqueous compositions comprising a poly (methacrylic acid)-block-poly(butyl methacrylate) polymer. The polymers do not contain monomers that promote adhesion to metal. The blocks of these block polymers are prepared by a cobalt catalyst mediated chain transfer polymerisation (CCTP) and not a RAFT polymerisation. The CCTP process affords less control of the functionality and polymer chains than a RAFT process.

US 2003-114548 describes various agents that may be used to control a RAFT polymerisation. The document teaches that aqueous polymer compositions may be obtained by emulsion polymerisation performed in present of a block polymer with active functional groups thereon. There is no teaching that RAFT polymers may be usefully coated onto metal substrates.

WO 2002-090392 describes aqueous compositions comprising a copolymer with at least one hydrophillic block (e.g. acrylic acid) and at least one hydrophobic block (e.g. butyl acrylate). The polymers are hydrophobic and designed to adhere to plastic substrates.

Surprisingly the applicant has found that reversible addition-fragmentation chain transfer (RAFT) polymerisation process provides a useful route for making adhesion promoting block copolymers that contain an adhesion promoting functional block next to at least a second, different, block. These block copolymers can provide waterborne coatings with advantageous adhesion promoting properties without the need of high levels of costly adhesion promoting monomers. RAFT polymerisation performed in for example a homogeneous solution avoids the undesirable homopolymerisation of adhesion promoting monomers with a high water solubility which can be detrimental to the metal adhesion and/or anti-corrosion properties. It is also possible with a RAFT process to fully control the polymer chain composition and the chain architecture of water-based polymers. By making an [A][B] type of block copolymer, followed by preparing a polymer P, some or all of the problems described herein may be mitigated. Waterborne polymer compositions having the desired combination of application properties like for example good resistances, good pigment wetting and good dry and wet adhesion to metal can be obtained.

Therefore broadly according to the invention there is provided an aqueous, metal, coating composition comprising a block copolymer and an emulsion polymer P; wherein the block copolymer comprises at least blocks [A]ₓ[B]_{y}, where at least block [A] is obtained and/or obtainable by a controlled radical polymerisation of at least one ethylenically unsaturated monomer via a reversible addition-fragmentation chain transfer (RAFT) mechanism in solution in the presence of a control agent and a source of free radicals; where:
(a) block [A] is obtained and/or obtainable from monomers comprising
   i) 0 to 80 mol % of ethylenically unsaturated monomers bearing metal adhesion promoting functional groups;
   ii) 0 to 100 mol % of ethylenically unsaturated monomers bearing water-dispersing functional groups;
   iii) 0 to 70 mol % of ethylenically unsaturated monomers selected from the group consisting of: C₁ to C₃₀ hydrocarbo (meth)acrylate (preferably C₁ to C₂₅ hydrocarbyl (meth)acrylate, more preferably C₁ to C₁₈ alkyl (meth)acrylate) monomers, styrenic monomers and mixtures thereof;
   iv) 0 to 35 mol % of ethylenically unsaturated monomer different from i), ii)+iii);
      where the amount of at least one of i), ii), iii)+iv) is >0 mol %;
      block [A] has a Hansch parameter <1.5; and
      block [A] has an average degree of polymerisation x, where x is an integer from 3 to 80; and
      preferably i), ii), iii) and iv) add up to 100% of the total monomers from which block [A] is obtained and/or obtainable; and
(b) block [B] is obtained and/or obtainable from monomers comprising:
   i) 0 to 50 mol % of ethylenically unsaturated monomes bearing metal adhesion promoting functional groups;
   ii) 0 to 15 mol % of ethylenically unsaturated monomers bearing water-dispersing functional groups;
   iii) 20 to 100 mol % of ethylenically unsaturated monomers selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers, styrenic monomers and mixtures thereof;
   iv) 0 to 35 mol % of ethylenically unsaturated monomers units different from those from i), ii)+iii);
      where block [B] has a Hansch parameter ≧1.5; and
      block [B] has an average degree of polymerisation y, where y is an integer ≧10, and y>x; and
      where preferably i), ii), iii)+iv) add up to 100% of the total monomers from which block [B] is obtained and/or obtainable; and
(c) polymer P is obtained and/or obtainable in the presence of the block copolymer [A][B] by an emulsion polymerisation process, and polymer P is obtained and/or obtainable from monomers comprising:
   i) 0 to 5% by weight of ethylenically unsaturated monomers bearing metal adhesion promoting functional groups;
   ii) 0 to 15% by weight of ethylenically unsaturated monomers bearing water-dispersing functional groups;
   iii) 50 to 100% by weight of ethylenically unsaturated monomers selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers, styrenic monomers and mixtures thereof;
   iv) 0 to 35% by weight of ethylenically unsaturated monomers different from those from i), ii)+iii);
      where preferably i), ii), iii)+iv) add up to 100% of the total monomers from which polymer P is obtained and/or obtainable.

As used herein metal coating composition means a coating that is capable of being applied to a metal surface so that it will substantially adhere thereto. In general the compositions of the invention may usefully be used to coat large surfaces that are substantially 2-dimensional (e.g. sheet or web) and for example it is preferred the surface to be coated is not that of a (metallic) particle. Preferred compositions of the invention are binder compositions.

In another aspect of the present invention there is provided a process for preparing an aqueous, metal, coating composition comprising a block copolymer and an emulsion polymer P; wherein the block copolymer comprising at least blocks [A]ₓ[B]_{y}, where the process comprises the steps of:
(a) obtaining at least block [A] by a controlled radical polymerisation of at least one ethylenically unsaturated monomer via a reversible addition-fragmentation chain transfer (RAFT) mechanism in solution in the presence of a control agent and a source of free radicals;
   where block [A] is obtained by polymerising monomers comprising
   i) 0 to 80 mol % of ethylenically unsaturated monomers bearing metal adhesion promoting functional groups;
   ii) 0 to 100 mol % of ethylenically unsaturated monomers bearing water-dispersing functional groups;
   iii) 0 to 70 mol % of ethylenically unsaturated monomers selected from the group consisting of: C₁ to C₃₀ hydrocarbo (meth)acrylate (preferably C₁ to C₂₅ hydrocarbyl (meth)acrylate more preferably C₁ to C₁₈ alkyl (meth)acrylate) monomers, styrenic monomers and mixtures thereof;
   iv) 0 to 35 mol % of ethylenically unsaturated monomer different from i), ii)+iii);
      where the amount of at least one of i), ii), iii)+iv) is >0 mol %;
      block [A] has a Hansch parameter <1.5; and
      block [A] has an average degree of polymerisation x, where x is an integer from 3 to 80; and
      preferably i), ii), iii) and iv) add up to 100% of the total monomers from which block [A] is obtained; and
(b) obtaining at least block [B] by polymerising monomers comprising:
   i) 0 to 50 mol % of ethylenically unsaturated monomers bearing metal adhesion promoting functional groups;
   ii) 0 to 15 mol % of ethylenically unsaturated monomers bearing water-dispersing functional groups;
   iii) 20 to 100 mol % of ethylenically unsaturated monomers selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers, styrenic monomers and mixtures thereof;
   iv) 0 to 35 mol % of ethylenically unsaturated monomers units different from those from i), ii)+iii);
      where block [B] has a Hansch parameter ≧1.5;
      block [B] has an average degree of polymerisation y, where y is an integer ≧10, where y>x; and
      preferably i), ii), iii)+iv) add up to 100% of the total monomers from which block [B] is obtained; and
(c) obtaining polymer P in the presence of the block copolymer [A][B] by emulsion polymerisation of:
   i) 0 to 5% by weight of ethylenically unsaturated monomers bearing metal adhesion promoting functional groups;
   ii) 0 to 15% by weight of ethylenically unsaturated monomers bearing water-dispersing functional groups;
   iii) 50 to 100% by weight of ethylenically unsaturated monomers selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers, styrenic monomers and mixtures thereof;
   iv) 0 to 35% by weight of ethylenically unsaturated monomers units different from those from i), ii)+iii);
      where preferably i), ii), iii)+iv) add up to 100% of the total monomers from which polymer P is obtained
      In another preferred embodiment of the invention the amount of i) in block [A]+i) in block [B] add up to >5 mol %.

In a yet other preferred embodiment of the invention: component (ii) of block [A] comprises >50% by weight (preferably >70% by weight) of a carboxylic acid functional ethylenically unsaturated monomer.

In a still other preferred embodiment of the invention: component (iii) of block [B] comprises >70% by weight (preferably >85% by weight) of a hydrophobic ethylenically unsaturated monomer selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers, styrenic monomers and mixtures thereof.

As used herein hydrophobic ethylenically unsaturated monomer denotes such monomers preferably having a Hansch parameter of at least 3.

Preferred hydrophobic ethylenically unsaturated monomers may comprise rings or other sterically bulky groups. More preferred hydrophobic ethylenically unsaturated monomers comprise cycloaliphatic groups (e.g. iso bornyl acrylate (IBOA)) and/or aromatic rings such as styrene.

In a still yet other preferred embodiment, the compositions of the invention are other than an aqeuous latex of 61% of butylacrylate, 36% stryene and 3% acrylamide (as described in comparative example Ex 2.6 in paragraph [0256] of US 2003-0114548). (Percentages are by weight of total monomers).

Preferably x is from 5 to 60; more preferably from 7 to 45.

Preferably y is from 15 to 200, more preferably from 20 to 100

Optionally preferred embodiments of the invention relate to block copolymer-polymer compositions where component i) (ethylenically unsaturated monomer units bearing metal adhesion promoting functional groups) are absent from block [A], block [B] and polymer P.

In a yet still other preferred embodiment of the invention the amount of i) in block [A]+i) in block [B] add up to >5 mol %.

In a yet other preferred embodiment of the invention:

component (ii) of block [A] comprises >50% by weight (preferably >70% by weight) of a carboxylic acid functional ethylenically unsaturated monomer;

component (iii) of block [B] comprises >70% by weight (preferably >85% by weight) of a hydrophobic (preferably Hansch parameter of >3) ethylenically unsaturated monomer selected from the group consisting of: C₁ to C₃₀ hydrocarbo (meth)acrylate (preferably C₁ to C₂₅ hydrocarbyl (meth)acrylate; more preferably C₁ to C₁₈ alkyl (meth)acrylate) monomers and styrenic monomers;

block [B] has a calculated Tg of at least 40° C., more preferably at least 60° C.

x is from 5 to 60; more preferably from 7 to 45; and

y is from 15 to 200, more preferably from 20 to 100

The average degree of polymerisation x (or y) is determined by the total molar amount of monomers in block [A] (or [B]) divided by the total molar amount of control (RAFT) agent.

The terms monomer, polymer, control agent, initiator, block are intended to cover the singular as well as the plural.

The block copolymer [A]ₓ[B]_{y} and polymer P are both obtained from ethylenically unsaturated monomers (vinyl monomers) and may therefore also be called a vinyl block copolymer and a vinyl polymer. As used herein block copolymer [A][B] denotes any block copolymer comprising at least one block of [A] and of [B] (and optionally other blocks of other monomers and/or other components) not necessary in the amounts of x and y as specified herein (e.g. block copolymers formed in a intermediate step in the process of the invention).

Preferably integer x is in the range of from 4 to 50, more preferably 5 to 40, and most preferably 8 to 35. Preferably integer y is from 5 to 500, more preferably from 10 to 300 and most preferably from 15 to 200. Preferably y>x. Preferably the ratio of y to x is from (55 to 45) to (99 to 1), more preferably from (65 to 35) to (95 to 5) and most preferably from (70 to 30) to (90 to 10). Optional advantages of the specified ratios of y to x for block [A] and block [B] are providing a good balance between water-dispersability of the block copolymer and the coating performance desired for outdoor metal coatings (e.g. measured by good wet adhesion and/or low water sensitivity).

Preferably the aqueous emulsion according to the invention comprises from 0.5 to 65 wt %, more preferably 1 to 50 wt %, even more preferably 2 to 35 wt %, especially 3 to 30 wt % and most preferably 4 to 25 wt % of blocks [A]ₓ[B]_{y} together, based on the weight of blocks [A]ₓ[B]_{y} and polymer P. The % by weight of the block copolymer [A]ₓ[B]_{y}, based on the total amount of block copolymer and polymer P is preferably within the specified boundaries to maintain optimal balance between desired level of activity of the block copolymer within the coating (in terms of sufficient adhesion to metal surfaces); and good overall coating performance properties provided by polymer P (in terms of for example film formation, stain resistances and mechanical properties). When the amount of block copolymer is higher than 65 wt %, the coating becomes more water-sensitive and might show reduced mechanical properties.

A block copolymer is understood to be a copolymer comprising at least two successive sections of blocks of monomer units of different chemical constitutions. The block copolymers of the invention can therefore be diblock, triblock or multiblock copolymers. Block copolymers may be linear, branched, star or comb like, and have structures like [A][B], [A][B][A], [A][B][C], [A][B][A][B], [A][B][C][B] etc. Preferably the block copolymer is a linear diblock copolymer of structure [A][B], or a linear triblock copolymer of structure [A][B][A]. Block copolymers may have multiple blocks [A], [B] and optionally [C] in which case the block copolymer is represented as for example [A]ₓ[B]_{y} or [A]ₓ[B]_{y}[C]_{z}, where x, y and z are the degrees of polymerisation (DP) of the corresponding blocks [A], [B] or [C].

Furthermore any of the blocks in the block copolymer could be either a homopolymer, meaning only one type of monomer, or a copolymer, meaning more than one type of monomer. In case of a copolymer type of block the composition could be either random or gradient like, depending on the processing conditions used. A block with a gradient composition is understood to be a block having a continuously changing monomer composition along the block.

The block copolymer may be oligomeric comprising only a few repeat units (such as up to 10) where typically any change in the number of repeat units may significantly effect the overall properties of the oligomer. Alternatively the block copolymer may be a polymer with many more repeat units in which typically a small change in the number of repeat units in the polymer has little or no effect on the polymer's properties.

Whatever its precise chemical composition or architecture, block [A] is prepared according to a controlled radical polymerisation process carried out in the presence of a control agent.

The term “controlled radical polymerisation” is to be understood as a specific radical polymerisation process, also denoted by the term of “living radical polymerisation”, in which use is made of control agents, such that the block copolymer chains being formed are functionalised by end groups capable of being reactivated in the form of free radicals by virtue of reversible transfer or reversible termination reactions.

Controlled radical polymerisation processes in which reversible deactivation of radicals proceeds by reversible transfer reactions include for example the process for radical polymerisation controlled by control agents, such as reversible transfer agents of the dithioester (R—S—C(═S)—R′) type as described in WO 98/01478 and WO 99/35178, the process for radical polymerisation controlled by reversible transfer agents of trithiocarbonate (R—S—C(═S)—S—R′) type as described in for example WO 98/58974, the process for radical polymerisation controlled by reversible transfer agents of xanthate (R—S—C(═S)—OR′) type as described in WO 98/58974, WO 00/75207 and WO 01/42312, and the process for radical polymerisation controlled by reversible transfer agents of dithiocarbamate (R—S—C(═S)—NR₁R₂) type as described for example in WO 99/31144 and WO 99/35177.

Such controlled radical polymerisations are known in the art as reversible addition-fragmentation chain transfer (RAFT) polymerisation (WO 98/01478; Macromolecules 1998 31, 5559-5562) or macromolecular design via interchange of xanthates (MADIX) polymerisation (WO 98/58974; Macromolecular Symposia 2000 150, 23-32).

“Addition-fragmentation” is a two-step chain transfer mechanism wherein a radical addition is followed by fragmentation to generate a new radical species.

When preparing for example a block copolymer in the presence of the control agent, the end of the growing block is provided with a specific functionality that controls the growth of the block by means of reversible free radical deactivation. The functionality at the end of the block is of such a nature that it can reactivate the growth of the block in a second and/or third stage of the polymerisation process with other ethylenically unsaturated monomers providing a covalent bond between for example a first and second block [A] and [B] and with any further optional blocks.

Preferably the block copolymer is obtained from a controlled radical polymerisation process employing as a control agent, a reversible transfer agent. Reversible transfer agents may be one or more compounds selected from the group consisting of dithioesters, thioethers-thiones, trithiocarbonates, dithiocarbamates, xanthates and mixtures thereof.

Reversible transfer agents also include symmetrical transfer agents. An example is a dibenzyltrithiocarbonate such as C₆H₅CH₂—S—C(═S)—S—CH₂C₆H₅.

Control agents of the xanthate type have low transfer constants in the polymerisation of styrenes and in particular methacrylate type monomers which may result in a higher polydispersity and/or poor chain growth control of the resultant polymers and may be considered as less effective RAFT control agents, although the actual mechanism involved is similar to the reversible-addition fragmentation chain transfer (RAFT) mechanism described in WO98/01478. Reversible transfer agents of the dithioester type like for example benzyl dithiobenzoate derivatives are generally considered as having a high transfer constant and being more effective RAFT control agents.

Transfer constants are described in WO98/01478. “Chain transfer constant” (CO means the ratio of the rate constant for chain transfer (kₜᵣ) to the rate constant for propagation (kₚ) at zero conversion of monomer and CTA. If chain transfer occurs by addition-fragmentation, the rate constant for chain transfer (kₜᵣ) is defined as follows:

kₜᵣ=k_{add}×[k_{β}/(k_{-add}+K_{β})]

where k_{add} is the rate constant for addition to the CTA and k_{-add} and k_{β} are the rate constants for fragmentation in reverse and forward directions respectively.

In an embodiment of the invention the control agent preferably has a transfer constant Cₜᵣ=(k_{add}/kₚ)[k_{β}/(k_{-add}+k_{β})] of less than 50, more preferably less than 20 and most preferably below 10.

Preferably the block copolymer is obtained from a controlled radical polymerisation process employing a control agent having a group with formula

—S—C(═S)—.

Preferably the block copolymer is obtained from a controlled radical polymerisation process employing xanthates and/or dibenzyltrithiocarbonate.

Preferably the block copolymer is obtained from a controlled radical polymerisation process employing a xanthate such as O-ethyl-S-(1-methoxycarbonyl) ethyl dithiocarbonate [RSC(═S)—OC₂H₅ where R═CH(CH₃)—C(═O)—OCH₃].

For clarity, control agents for use in RAFT do not include diphenylethylene, which although it is a control agent can not be used as a RAFT control agent, i.e. for a RAFT polymerisation mechanism.

The process for radical polymerisation controlled by for example control agents of xanthate type may be carried out in bulk, in solution, in emulsion, in dispersion or in suspension.

Conveniently component i) may comprise ethylenically unsaturated monomer units bearing metal adhesion promoting functional groups, which may comprise any of the following and combinations or mixtures thereof: monomers with phosphate functionality; monomers with phosphonate functionality; monomers with phosphonic acid functionality; monomers with sulphonic acid functionality; monomers with (meth)acryloylpropionic acid functionality; monomers with anhydride functionality; monomers with acetoacetoxy functionality; monomers with amine functionality; monomers with amide functionality; monomers with silane functionality; monomers with ureido functionality; and mixtures thereof.

Monomers with phosphate, phosphonate or phosphonic acid functionality include 2-(meth)acrylamido-2-methylpropane phosphonic acid, vinyl phosphonic acid, phosphoalkyl (meth)acrylates such as phosphoethyl (meth)acrylate (“PEM”), phosphopropyl (meth)acrylate, and phosphobutyl (meth)acrylate, phosphoalkyl crotonates, phosphoalkyl maleates, phosphoalkyl fumarates, phosphodialkyl (meth)acrylates, phosphodialkyl crotonates, allyl phosphate, and the corresponding alkali metal salts or other salts of the acid containing monomers. Other monomers bearing phosphate or phosphonate functional groups are listed for example in US2005/0181225, examples of which include N-(meth)acrylamidoalkylphosphonic acid ester derivatives, vinylbenzylphosphonate dialkyl ester derivatives, diethyl 2-(4-vinylphenyl)ethane phosphonate, dialkylphosphonoalkyl (meth)acrylate derivatives, vinyl phosphonic acid derivatives, 2-(methacryloyloxy)alkyl phosphates (for example phosphated 2-hydroxyethyl methacrylate), and 2-(acryloyloxy)alkyl phosphates (for example phosphated 2-hydroxyethyl acrylate), where “alkyl” typically includes methyl, ethyl, propyl (all isomers) and butyl (all isomers). Also included are ethoxylated or propoxylated versions thereof. Preferably, the monomers with phosphate, phosphonate or phosphonic acid functionality have a high monoalkyl phosphate content and a low dialkyl phosphate and residual phosphoric acid content. Examples of commercially available monomers with phosphate, phosphonate or phosphonic acid functionality include Sipomer PAM-100, Sipomer PAM-200 and Sipomer PAM-300 (all available from Rhodia). Preferably the monomers with phosphate, phosphonate or phosphonic acid functionality are selected from the group consisting of vinyl phosphonic acid, phosphoethyl methacrylate, 2-(methacryloyloxy)alkyl phosphates, 2-(acryloyloxy)alkyl phosphates, Sipomer PAM-100, Sipomer PAM-200 and Sipomer PAM-300.

Monomers with sulphonic acid functionality include styrenesulphonic acid, vinylsulphonic acid, sulphoethyl acrylate, 2-sulphoethyl methacrylate, ethylmethacrylate-2-sulphonic acid, acryloyloxyalkyl sulphonic acids (for example acryloyloxymethyl sulphonic acid), 2-acrylamido-2-alkylalkane sulphonic acids (for example 2-acrylamido-2-methylpropane sulphonic acid (AMPS)), 2-methacrylamido-2-alkylalkane sulphonic acids (for example 2-methacrylamido-2-methylethanesulphonic acid), 1-allyloxy-2-hydroxypropane sulphonic acid, allyl sulphosuccinic acid, and the corresponding alkali metal salts or other salts of the acid containing monomers. Preferably the monomer with sulphonic acid functionality is selected from the group consisting of acryloyloxyalkyl sulphonic acids and AMPS.

Monomers with (meth)acryloylpropionic acid functionality include monomers having the chemical formula:

CH₂═C(R)C(O)(OCH₂CH₂C(O))ₙOH

wherein n is from 1 to about 6 and R is H or CH₃. Preferably the monomer with (meth)acryloylpropionic acid functionality is beta-carboxyethyl acrylate (for example Sipomer B-CEA, available from Rhodia).

Monomers with anhydride functionality include, but are not limited to, maleic anhydride, methacrylic anhydride, itaconic anhydride, citraconic anhydride. Most preferably the monomer with anhydride functionality is maleic anhydride. Maleic anhydride is preferably incorporated by copolymerisation with styrene, which preferably results in an alternating copolymer that can optionally be dissolved or dispersed in water under alkaline conditions.

Monomers with acetoacetoxy functionality include acetoacetoxyalkyl (meth)acrylates and acetoacetamidoalkyl (meth)acrylates where “alkyl” includes ethyl, propyl (all isomers), and butyl (all isomers); and allyl acetoacetate. Particularly preferred is acetoacetoxyethyl methacrylate (AAEM). An advantage of using monomers with acetoacetoxy functionality is that they are capable of forming a chelating interaction with a metal surface which promotes adhesion to a metal surface.

Monomers with amine functionality include 2-dimethylaminoethyl (meth)acrylate (DMAE(M)A), 2-aminoethyl (meth)acrylate, 2-diethylaminoethyl (meth)acrylate, 3-di methylaminopropyl (meth)acrylate, 3-dimethylamino-2,2-dimethylpropyl(meth)acrylate, N-t-butylaminoethyl (meth)acrylate, dimethylaminoneopentyl acylate, N-(meth)acryloyl sarcosine methyl ester, 2-N-morpholinoethyl (meth)acrylate, 2-N-piperidinoethyl (meth)acrylate, 3-dimethylaminopropyl (meth)acrylamide, 2-dimethylaminoethyl (meth)acrylamide, 2-diethylaminoethyl (meth)acrylamide, oxazolidinylethyl (meth)acrylate, N,N-dimethylvinyl benzylamine, p-aminostyrene, N,N-cyclohexylallylamine, allylamine, diallylamine, dimethylallylamine, N-ethyldimethylallylamine, crotyl amines and N-ethylmethallylamine. Also included are monomers having a pyridine functionality, which includes 2-vinylpyridine and 4-vinylpyridine; monomers having piperidine functionality, such as vinylpiperidines; and monomers having imidazole functionality, such as vinyl imidazole and N-(4-morpholinoethyl) (meth)acrylamidevinylimidazole. A preferred monomer with amine functionality is 2-dimethylaminoethyl methacrylate (DMAEMA).

Monomers with amide functionality include vinyl pyrrolidone, (meth)acrylamide, and N-substituted (meth)acrylamides such as N,N-dimethylacrylamide and N-methylol acrylamide, N-(3-dimethylaminopropyl) (meth)acrylamide, N-(3-dimethylamino-2,2-dimethylpropyl) (meth)acrylamide, N-dimethylaminoethyl (meth)acrylamide, N-dimethylaminomethyl (meth)acrylamide, N-(4-morpholino-methyl) (meth)acrylamide. A preferred amide functional monomer is (meth)acrylamide.

Monomers with silane functionality include alkoxysilane functional monomers and vinyl silane functional monomers. Examples of alkoxysilane functional monomers include vinyltrialkoxysilanes such as vinyltrimethoxysilane and vinyltriethoxysilane, vinylmethyldialkoxysilanes such as vinylmethyldimethoxysilane, and (meth)acryloxypropyltri(alkoxy) silanes such as gamma-methylacryloxypropyltrimethoxy silane and gamma-methylacryloxypropyltriethoxy silane. Examples of vinyl silane functional monomers are vinyl trimethoxysilane and vinyl trichlorosilane. Examples of commercially available silane functional monomers include Z-6030 and Z-6300, both available from Dow Corning, and Silquest A-2171, Silquest A-174, CoatOSil 1757, Silquest A-151, Silquest A-171 and Silquest A-172, all available from OSi Specialty Chemicals. Preferred monomers with silane functionality are alkoxysilane functional monomers, most preferably gamma-methylacryloxypropyltrimethoxy silane or gamma-methylacryloxypropyltriethoxy silane.

Monomers with ureido functionality include N-(2-methacrylamidoethyl) ethylene urea (for example Sipomer WAM II, available from Rhodia), N-(2-methacryloyloxyethyl)ethylene urea (for example Plex 6852-O, available from Degussa, or Norsocryl 104, available from Ato Fina), N-(2-methacryloxyacetamidoethyl)-N,N′-ethylene urea, allyl ureido wet adhesion monomer (Sipomer WAM, available from Rhodia), allylalkyl ethylene urea, Cylink C4 wet adhesion monomer (available from Cytec), N-methacrylamido-methyl urea, N-methacryloyl urea, N-[3-(1,3-diazacyclohexan-2-one)propyl]methacrylamide, 2-(1-imidazolyl)ethyl methacrylate and 2-(1-imidazolidin-2-on)ethyl methacrylate. Preferred monomers with ureido functionality are N-(2-methacrylamidoethyl)ethylene urea and N-(2-methacryloyloxyethyl)ethylene urea.

Preferably the ethylenically unsaturated monomer units bearing adhesion promoting functional groups are selected from the group consisting of monomers with phosphate functionality; monomers with phosphonate functionality; monomers with phosphonic acid functionality; monomers with sulphonic acid functionality; monomers with (meth)acryloylpropionic acid functionality; monomers with anhydride functionality; monomers with acetoacetoxy functionality; monomers with ureido functionality and mixtures thereof.

More preferably the ethylenically unsaturated monomer units bearing adhesion promoting functional groups are selected from the group consisting of vinyl phosphonic acid, phosphoethyl methacrylate, 2-(methacryloyloxy)alkyl phosphates, 2-(acryloyloxy)alkyl phosphates, Sipomer PAM-100, Sipomer PAM-200, Sipomer PAM-300 (Sipomer PAM grades are commercially available from Rhodia), acryloyloxyalkyl sulfonic acids, AMPS, beta-carboxyethyl acrylate, maleic anhydride, AAEM, DMAEMA, (meth)acrylamide, gamma-methylacryloxypropyltrimethoxy silane, gamma-methylacryloxypropyltriethoxy silane, N-(2-methacrylamidoethyl)ethylene urea, N-(2-methacryloyloxyethyl)ethylene urea and mixtures thereof.

Preferably block [A] is obtained, is obtainable and/or comprises from 0 to 70 mol % (of total of components (a)(i) to (b)(iv)), more preferably from 0.1 to 70 mol %, most preferably from 5 to 60 mol % and especially from 10 to 55 mol % of component i).

Preferably block [B] is obtained, is obtainable and/or comprises from 0 to 40 mol % (of total of components (b)(i) to (b)(iv)), more preferably from 0.1 to 40 mol %, most preferably from 5 to 35 mol % and especially from 7 to 25 mol % of component i).

Preferably polymer P is obtained, is obtainable and/or comprises from 0 to 3% by weight (of total of components (c)(i) to (c)(iv)), more preferably up to 2% by weight, most preferably up to 1% by weight, most preferably is substantially free of component i).

When component i) comprises a hydrophilic (water-soluble or potentially water-soluble) metal adhesion promoting monomer, such as for example maleic anhydride or vinyl phosphonic acid, then preferably 70 to 100 wt %, more preferably 85 to 100 wt % of the total amount of hydrophilic metal adhesion promoting monomer is incorporated in block [A].

When component i) comprises a hydrophobic metal adhesion promoting monomer, such as for example Sipomer PAM200, then preferably 70 to 100 wt %, more preferably 85 to 100 wt % of the total amount of hydrophobic metal adhesion promoting monomer is incorporated in block [B].

Optionally the compositions of the present invention comprise acrylamide in an amount of less 3% by weight of the total monomers of the composition. Further optionally component i) herein is other than acrylamide.

For the purpose of this invention, monomers which may also provide some water-dispersing properties such as for example monomers with phosphonic acid, sulphonic acid, (meth)acryloylpropionic acid and anhydride functionality which may be neutralised upon addition of a base, herein are considered as monomers providing metal adhesion functional groups, i.e. component i).

For clarity, monomers which may also provide crosslinking properties such as for example monomers with anhydride functionality (for example maleic anhydride) that may also be used for crosslinking with for example a polyamine crosslinker or a multifunctional hydrazine derivative, herein are considered as monomers providing metal adhesion functional groups, i.e. component i).

Conveniently component ii) may comprise ethylenically unsaturated monomer units bearing nonionic, ionic or potentially ionic water-dispersing functional groups. Preferably the water-dispersing functional groups bearing ionic or potentially ionic functional groups are in their dissociated (i.e. salt) form to effect their water-dispersing action. If they are not dissociated they are considered as potential ionic groups which become ionic upon dissociation. The ionic water-dispersing groups are preferably fully or partially in the form of a salt in the final composition of the invention. Ionic water-dispersing groups include cationic water-dispersing groups such as quaternary ammonium groups and (potentially) anionic water-dispersing groups such as carboxylic acid groups. Preferably any ionic water-dispersing groups are anionic water-dispersing groups.

Preferred ethylenically unsaturated monomer units bearing ionic or potentially ionic water-dispersing functional groups include (meth)acrylic acid, itaconic acid, monoalkyl maleates (for example monomethyl maleate and monoethyl maleate), citraconic acid and/or mixtures thereof. Ethylenically unsaturated monomer units bearing water-dispersing functional groups may also include ethylenically unsaturated monomer units bearing non-ionic water-dispersing groups such as pendant polyoxyalkylene groups, more preferably polyoxyethylene groups such as methoxy(polyethyleneoxide (meth)acrylate), hydroxy polyethylene glycol (meth)acrylates, alkoxy polypropylene glycol (meth)acrylates and hydroxy polypropylene glycol (meth)acrylates, preferably having a number average molecular weight of from 350 to 3000 g/mol. Examples of such ethylenically unsaturated monomers which are commercially available include w-methoxypolyethylene glycol (meth)acrylate.

Preferably ethylenically unsaturated monomer units bearing water-dispersing or potentially water-dispersing functional groups are selected from the group consisting of anionic water-dispersing or potentially anionic water-dispersing functional groups, non-ionic water-dispersing groups and mixtures thereof.

Preferably component ii) is acrylic acid.

For the purpose of this invention, monomers which may also provide some crosslinking properties such as (meth)acrylic acid, herein are considered as monomers providing water-dispersing functional groups, i.e. component ii).

Preferably block [A] is obtained, is obtainable and/or comprises from 20 to 100 mol % (of total of components (a)(i) to (a)(iv)), more preferably from 30 to 100 mol % and especially from 35 to 80 mol % of component ii).

Preferably block [B] is obtained, is obtainable and/or comprises from 0 to 10 mol % (of total of components (b)(i) to (b)(iv)), more preferably from 0 to 7 mol % and especially from 1 to 5 mol % of component ii).

Preferably polymer P is obtained, is obtainable and/or comprises from 0 to 5% by weight (of total of components (c)(i) to (c)(iv)), more preferably from 0 to 3% by weight, most preferably up to 2% by weight, most preferably is substantially free of component ii).

Conveniently component iii) may comprise optionally substituted monomers such as C₁₋₁₈ hydrocarbo (meth)acrylates, C₁₋₁₈ hydrocarbo acrylamide and/or styrenic monomers.

More conveniently component iii) may comprise: styrene, α-methyl styrene, t-butyl styrene, chloromethyl styrene, esters of acrylic and/or methacrylic acid(s), represented by Formula 1

CH₂═CR⁵—COOR⁴ Formula 1

wherein R⁵ is H or methyl and R⁴ is optionally substituted C₁-₁₈ hydrocarbyl (e.g. alkyl, cycloalkyl, aryl and/or (alkyl)aryl) and/or optionally substituted C₁-₁₈ hydrocarbyl (meth)acrylamides. The esters of Formula 1 are also known as acrylic monomers.

Most conveniently component iii) may comprise monomers selected from the group consisting of: styrene, α-methylstyrene, t-butyl styrene, chloromethyl styrene, optionally substituted C₁-₁₈ alkyl, (meth)acrylate(s), optionally substituted C₃-₁₈ cycloalkyl (meth)acrylate(s), optionally substituted C₃-₁₈ aryl (meth)acrylate(s), optionally substituted C₄-₁₈ (alkyl)aryl) (meth)acrylate(s), hydrophobic acrylic monomers (such as side-chain crystallisable monomers), optionally substituted C₁-₁₈ alkyl acrylamide, optionally substituted C₃-₁₈ cycloalkyl acrylamide, optionally substituted C₃-₁₈ aryl acrylamide, optionally substituted C₄-₁₈ (alkyl)aryl) acrylamide and mixtures thereof.

Usefully component iii) may comprise monomers selected from the group consisting of: styrene, α-methylstyrene, t-butyl styrene, chloromethyl styrene, methyl (meth)acrylate, ethyl (meth)acrylate, propyl (meth)acrylate (all isomers), butyl (meth)acrylate (all isomers), 2-ethylhexyl (meth)acrylate, isodecyl (meth)acrylate, lauryl (meth)acrylate, tridecyl (meth)acrylate, isobornyl (meth)acrylate, dicyclopentenyloxymethyl (meth)acrylate, benzyl (meth)acrylate, 2-phenoxyethyl (meth)acrylate, 3,3,5-trimethyl-cyclohexyl (meth)acrylate, p-methylphenyl (meth)acrylate, 1-naphtyl (meth)acrylate, 3-phenyl-n-propyl (meth)acrylate, tetradecyl (meth)acrylate, hexadecyl (meth)acrylate, octadecyl (meth)acrylate (=stearyl (meth)acrylate), t-octyl (meth)acrylamide, n-decyl (meth)acrylamide and mixtures thereof.

Preferably, the monomers are selected from styrene, isobornyl (meth)acrylate, and the group of C₁ to C₁₂, more preferably C₁ to C₈ alkyl (meth)acrylate monomers including methyl (meth)acrylate, ethyl (meth)acrylate, propyl (meth)acrylate (all isomers), butyl (meth)acrylate (all isomers) and 2-ethylhexyl (meth)acrylate.

Preferably block [A] is obtained, is obtainable and/or comprises from 0 to 60 mol % (of total of components (a)(i) to (a)(iv)), more preferably from 0.1 to 60 mol %, most preferably from 5 to 50 mol % and especially from 10 to 55 mol % of component iii).

Preferably block [B] is obtained, is obtainable and/or comprises from 40 to 100 mol % (of total of components (b)(i) to (b)(iv)), more preferably from 50 to 95 mol % and most preferably from 60 to 90 mol % of component iii).

Preferably polymer P is obtained, is obtainable and/or comprises from 60 to 100% by weight (of total of components (c)(i) to (c)(iv)), more preferably from 65 to 100 wt % and most preferably from 70 to 100 wt % of component iii).

Conveniently component iv) may comprise diene monomers such as 1,3-butadiene and isoprene; vinyl toluene; divinyl benzene; vinyl monomers such as acrylonitrile, methacrylonitrile; vinyl halides such as vinyl chloride; vinylidene halides such as vinylidene chloride; vinyl esters such as vinyl acetate, vinyl propionate, vinyl laurate; vinyl esters of versatic acid such as VEOVA™ 9 and VEOVA™ 10 (VEOVA™ is a trademark of Resolution); heterocyclic vinyl compounds; alkyl esters of mono-olefinically unsaturated dicarboxylic acids such as di-n-butyl maleate and di-n-butyl fumarate; amides of unsaturated carboxylic acids such as N-alkyl(meth)acrylamides that are different from those of components i) to iii).

Examples of component iv) may also include ethylenically unsaturated monomers (usually C₁ to C₁₂ alkyl (meth)acrylates) bearing crosslinking functional groups like hydroxyl, epoxy, unsaturated fatty acid, (meth)acryloyl or (meth)allyl functional groups, examples of which include hydroxyalkyl (meth)acrylates such as hydroxyethyl (meth)acrylate (HE(M)A), 2-hydroxypropyl (meth)acrylate, 4-hydroxybutyl (meth)acrylate and their modified analogues like Tone M-100 (Tone is a trademark of Union Carbide Corporation), glycidyl (meth)acrylate, allyl (meth)acrylate, and/or mixtures thereof.

Preferred monomers suitable for crosslinking include for example hydroxyalkyl (meth)acrylates and glycidyl (meth)acrylates.

For clarity, monomers which may also provide some water-dispersing properties, such as hydroxyalkyl (meth)acrylates like for example hydroxyethyl (meth)acrylate (HE(M)A), herein are considered as ethylenically unsaturated monomers providing crosslinking functional groups and therefore as component iv).

Preferably block [A] is obtained, is obtainable and/or comprises from 0 to 30 mol % (of total of components (a)(i) to (a)(iv)), more preferably from 0.1 to 30 mol %, most preferably from 1 to 25 mol % and especially 2 to 20 mol % of component iv).

Preferably block [B] is obtained, is obtainable and/or comprises from 0 to 30 mol % (of total of components (b)(i) to (b)(iv)), more preferably 0 to 25 mol % (e.g. 0.1 to 25 mol %) and most preferably 2 to 20 mol % of component iv).

Preferably polymer P is obtained, is obtainable and/or comprises from 0 to 20% by weight (of total of components (c)(i) to (c)(iv)) (e.g. 0.1 to 20 wt %), more preferably 0 to 10 wt % (e.g. 0.5 to 10 wt %) and most preferably 0 to 5 wt % (e.g. 1 to 5 wt %) of component iv).

The weight average molecular weights (Mw) or number average molecular weights (Mn) of the block copolymer may be determined by using gel permeation chromatography (GPC).

Preferably the number average molecular weight (Mn) of block [A] is in the range of from 200 to 15,000 g/mol, more preferably from 500 to 10,000 g/mol and most preferably from 700 to 7,000 g/mol. The advantage of having a Mn for block [A] within the specified boundaries is to maintain a good balance between water-sensitivity of the final coating (which increases when Mn is higher than 15,000 g/mol) and water-dispersability of the block copolymer (which is poor when Mn is lower than 200 g/mol).

Preferably the Mn of block [B] is in range of from 750 to 75,000 g/mol, more preferably from 2,000 to 50,000 g/mol and most preferably from 3,000 to 30,000 g/mol. The advantage of having a Mn for block [B] within the specified boundaries is to maintain a good water-dispersability of the block copolymer; when the Mn is higher than 75,000 g/mol the block copolymer cannot be dispersed properly and when the Mn is lower than 750 g/mol the block copolymer is too water-soluble, which can give issues regarding water-sensitivity and wet adhesion of the coating.

Preferably the ratio of Mn value for block [B] to that of block [A] is in the range of from 55:45 to 99:1, more preferably in the range of from 60:40 to 94:6 and most preferably in the range of from 65:35 to 90:10. The advantage of having such a ratio of Mn for block [B] to block [A] is the provision of a good balance between water-dispersability of the block copolymer and the coating performance in terms of water sensitivity, wet adhesion properties and mechanical properties desired for outdoor coatings on metal substrates.

Preferably block copolymer [A]ₓ[B]_{y} has a number average molecular weight ≦50,000 g/mol, more preferably ≦35,000 g/mol and especially ≦25,000 g/mol.

Preferably block copolymer [A]ₓ[B]_{y} has a weight average molecular weight ≦100,000 g/mol, more preferably ≦75,000 g/mol and especially ≦50,000 g/mol.

Preferably polymer P has a weight average molecular weight ≦1,000,000 g/mol, more preferably ≦750,000 g/mol and especially ≦500,000 g/mol.

Preferably the composition (block copolymer [A]ₓ[B]_{y} and polymer P) has a weight average molecular weight in the range of from 2,000 to 750,000 g/mol, more preferably 10,000 to 500,000 and especially 20,000 to 400,000 g/mol.

The Tg of a polymer herein stands for the glass transition temperature and is well known to be the temperature at which a polymer changes from a glassy, brittle state to a rubbery state. Tg values of polymers may be determined experimentally using techniques such as Differential Scanning Calorimetry (DSC) or calculated theoretically using the well-known Fox equation where the Tg (in Kelvin) of a copolymer having “n” copolymerised comonomers is given by the weight fractions “W” and the Tg values of the respective homopolymers (in Kelvin) of each comonomer type according to the equation “1/Tg=W₁/Tg₁+W₂/Tg₂+ . . . Wₙ/Tgₙ”. The calculated Tg in Kelvin may be readily converted to ° C.

Preferably the Tg of block [A] is −20° C. to 250° C., more preferably 0° C. to 200 C and most preferably 10° C. to 180° C.

Preferably the Tg of block [B] is ≦50° C., more preferably ≦35° C. and most preferably ≦25° C. The advantage of having a Tg of block [B] within the specified boundaries is that a lower Tg can promote the dispersability and flexibility of the block copolymer. A high flexibility of the block copolymer gives a good chain mobility within the coating, which is advantageous for obtaining good adhesion of the coating to the substrate surface.

Preferably the Tg of block [A] is higher than the Tg of block [B]. Preferably the difference in Tg between block [A] and block [B] is ≧20° C., more preferably ≧40° C. and especially ≧50° C.

Preferably the Tg of polymer P is ≧0° C., more preferably in the range of from 5 to 80° C., most preferably 10 to 60° C. and especially 10 to 50° C.

Preferably block [B] and polymer P are more hydrophobic than block [A]. The hydrophobicity of a polymer may be determined from the Hansch parameter. The Hansch parameter for a polymer is calculated using a group contribution method. The monomer units forming a polymer are assigned a hydrophobicity contribution and the hydrophobicity of the polymer, the Hansch parameter, is calculated based on the weight average of the monomers in the polymer as disclosed in for example C. Hansch, P. Maloney, T. Fujita, and R. Muir, Nature, 194. 178-180 (1962). Values of the hydrophobicity contributions for several monomers are for example: styrene 4.29, α-methylstyrene 4.7, methyl methacrylate 1.89, butyl acrylate 3.19, acrylic acid −2.52, and maleic anhydride −3.5. Therefore a polymer made up of STY (20) αMS (20) MMA (20) BA (10) AA (30) has a Hansch value of 1.74.

Preferably the Hansch parameter for block [A] is lower than that for block [B] and lower than that for polymer P.

Preferably block [A] has a Hansch parameter ≦than 1.2, more preferably ≦1.0, most preferably ≦0.8 and especially ≦0.6.

Preferably block [B] has a Hansch parameter ≧1.7, more preferably ≧2.0 and especially ≧2.2.

Preferably polymer P has a Hansch parameter ≧2.2, more preferably ≧2.5 and especially ≧2.7.

Preferably block [A] has a calculated Hansch parameter ≦0.8, more preferably ≦−0.5.

Preferably block [B] has a calculated Hansch parameter ≧3.0, more preferably ≧3.5

Preferably block [A] is obtained from at least acrylic acid monomer.

Preferably block [B] is obtained from at least monomers selected from the group consisting of: styrene and C₈-C₁₈ hydrocarbo (meth)acrylates (such as 2-ethylhexyl (meth)acrylate, isodecyl (meth)acrylate, lauryl (meth)acrylate, tridecyl (meth)acrylate, isobornyl (meth)acrylate, benzyl (meth)acrylate, tetradecyl (meth)acrylate, hexadecyl (meth)acrylate, and octadecyl (meth)acrylate (=stearyl (meth)acrylate)) and mixtures thereof.

The block copolymer [A]ₓ[B]_{y} preferably has an acid value in the range of from 5 to 200 mgKOH/g and more preferably 20 to 150 mgKOH/g of block copolymer [A]ₓ[B]_{y}.

Polymer P preferably has an acid value ≦50, more preferably <15 and especially <10 mgKOH/g of polymer.

The aqueous emulsion of the invention preferably has an acid value ≧100, more preferably <70 and especially <50 mgKOH/g of total polymer in the composition.

The RAFT polymerisation process for obtaining block [A] is performed in solution. The RAFT polymerisation process for obtaining block [B] may be performed in bulk, in solution, in emulsion, in dispersion, or in suspension. Preferably the RAFT polymerisation process for obtaining block [B] is performed in solution or in emulsion, more preferably in solution. Solution polymerisation is a polymerisation process in which all the reaction components including the monomers, initiator and control agent are dissolved in a non-monomeric liquid solvent either at the start or during the course of the reaction. By non-monomeric is meant a solvent that does not comprise monomers, in other words the solvent won't react as part of the polymerisation. Usually the solvent is also able to dissolve the vinyl polymer or copolymer that is being formed. By a solvent is meant water, organic solvents or mixtures thereof.

The term “comprising” as used herein means that the list that immediately follows is non exhaustive and may or may not include any other additional suitable items, for example one or more further feature(s), component(s), ingredient(s) and/or substituent(s) as appropriate. “Substantially comprising” as used herein means a component or list of component(s) is present in a given material in an amount greater than or equal to about 90%, preferably ≧95%, more preferably ≧98% by weight of the total amount of the given material. The term “consisting of” as used herein mean that the list that follows is exhaustive and does not include additional items.

For all upper and lower boundaries of any parameters given herein, the boundary value is included in each range for each parameter. All combinations of minimum and maximum values of the parameters described herein may be used to define the parameter ranges for various embodiments and preferences of the invention.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non-exhaustive the sum of the percentage for each of such components may be less than 100% to allow a certain percentage for additional amount(s) of any additional component(s) that may not be explicitly described herein. For example the percentages described herein (whether as mole % or weight %) for the polymer [P] and parts thereof (e.g. blocks [A] and [B]) relate to the percentage of the total monomers from which the relevant polymer or part thereof is obtained or obtainable. In one (preferred) embodiment of the invention the components specified herein (e.g. (a)(i) to (a) iv) for block [A], (b)(i) to (b) iv) for block [B] and/or (c)(i) to (c) iv) for polymer P) sum 100% (i.e. no other monomers or units derived therefrom, comprise the relevant polymer or part thereof). However it will be appreciated that in another embodiment of the invention monomers (or units derived therefrom) in addition to those specified above may also comprises the relevant polymer or part thereof so the components described above would then add up to less than 100% of the relevant polymer or part therein.

Unless the context clearly indicates otherwise, as used herein plural forms of the terms herein (for example monomer, polymer, control agent, initiator and/or block) are to be construed as including the singular form and vice versa.

As used herein chemical terms (other than IUPAC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

The terms ‘optional substituent’ and/or ‘optionally substituted’ as used herein (unless followed by a list of other substituents) signifies the one or more of following groups (or substitution by these groups): carboxy, sulpho, sulphonyl, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy, more preferred being methyl, hydroxyl and cyano.

The term ‘hydrocarbo group’ as used herein denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}hydrocarbo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in a hydrocarbo group is from 1 to 12, especially from 1 to 10 inclusive, for example from 1 to 4 carbon atoms.

The substituents on the repeating unit of the polymer and/or block copolymer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or crosslinking with such other resins as appropriate.

Preferably the block copolymer is prepared according a solution dispersion polymerization process, which comprises the preparation of the block copolymer in solution using a RAFT radical polymerisation process and the dispersion of the obtained block copolymer in water. Dispersion of the block copolymer in water can be performed by adding water to the block copolymer solution or by adding the block copolymer solution to water. Optionally suitable surfactants can be used to aid in the dispersion process. The block copolymer preferably comprises acid-functional groups that can be transformed into anionic functional water-dispersing groups by addition of a suitable organic or inorganic base such as for example ammonia, triethylamine or sodium hydroxide. Preferred bases are volatile amines, such as ammonia, or neutralizing agents which decompose without leaving inorganic residues which are sensitive to water in the final dried coating. After the block copolymer is dispersed in water the remaining solvent can optionally be removed for example under reduced pressure.

Preferred organic solvents include alcohols (such as ethanol, isopropanol, n-butanol, n-propanol, cyclohexanol), esters (such as ethyl acetate, propyl acetate, isopropyl acetate, butyl acetate), ketone solvents (such as acetone, methyl ethyl ketone, methyl isobutyl ketone), and glycols (such as butyl glycol). More preferred organic solvents include solvents selected from the group consisting of acetone, ethanol, methyl ethyl ketone, iso-propanol, ethyl acetate, butyl glycol and mixtures thereof. Preferably the solvent is a mixture of water and a suitable organic solvent like an alcohol. Preferably the solvent applied for the block copolymer preparation using the solution dispersion polymerisation process comprises an organic solvent with a low boiling point and or a high evaporation rate to allow fast removal of the organic solvent after the dispersion step under reduced pressure. Examples of such solvents include acetone, ethanol, isopropanol, methyl ethyl ketone and ethyl acetate.

A process for preparing a block having a gradient composition comprises continually introducing a first monomer feed to a reactor, where the first monomer feed continually varies in its compositional feed content during the continuous introduction by the addition of a different second monomer feed to the first monomer feed and polymerising the monomers introduced into the reactor.

The addition of the second monomer feed to the first monomer feed may be in parallel to the introduction of the first monomer feed to the polymerisation (i.e. both feeds start and end at the same time). Alternatively the start of monomer feed one to the reactor may precede the start of the addition of the second monomer feed to the first monomer feed, or both monomer feeds may be started simultaneously but the time taken for the addition of the second monomer feed to the first monomer feed may exceed the time taken for the introduction of the first monomer feed to the reactor.

A block having a gradient composition may also be obtained by the simultaneous introduction of a first and a second monomer feed into the reactor where the rate of the introduction of the first monomer feeds varies with respect to the rate of the introduction of the second monomer feed.

The at least two monomer feeds used to prepare the block having a gradient composition usually differ in composition. The difference between the at least two monomer feeds may be for example a difference in monomer composition, a difference in glass transition temperature (Tg), or simply a variation in the concentration of the respective monomers in each monomer feed.

Block [A] and [B] can be prepared in any order.

Polymer P is prepared using a radical emulsion polymerisation process in the presence of the block copolymer [A]ₓ[B]_{y}, where optionally the control agent functional group located at one of the chain ends of the prepared block copolymer [A]ₓ[B]_{y} can be deactivated or removed prior to the preparation of polymer P. General methods for preparing aqueous vinyl polymers are reviewed in the Journal of Coating Technology, volume 66, number 839, pages 89 to 105 (1995). The control agent may optionally be removed before or after dispersion of the block copolymer and before or after the polymer preparation. When a RAFT agent is used as control agent the RAFT group can be deactivated or removed via for example oxidation reactions, radical induced reactions, hydrolysis, or aminolysis. In the case that the control agent functional group is not removed or only partially removed prior to the preparation of polymer P at least part of the polymer P chains will grow onto or become covalently attached to at least part of the block copolymer chains.

Optionally the chain end functionality of the block copolymer [A]ₓ[B]_{y}, is retained to assist with the covalent bond formation between the block copolymer and polymer P. The chain end functionality of the block copolymer may be a RAFT group (—S—C(═S)—) or a thiol (—SH) group or any other group derived from the RAFT control agent that can provide covalent bond formation between the block copolymer and polymer P.

In another embodiment of the invention there is provided a process for preparing a composition according to the invention wherein said method comprises the following steps:
1. synthesis in a solvent by means of a RAFT radical polymerisation process of a first block [A] followed by the polymerisation of at least a second block [B]. The order of preparation of [A] and [B] can also be reversed;
2. optional removal of the control agent before, during or after dispersing the block copolymer [A]ₓ[B]_{y} in water;
3. optional removal of the solvent from block copolymer [A]ₓ[B]_{y};
4. dispersion of the block copolymer [A]ₓ[B]_{y} in water optionally containing monomers, by adding either water to the block copolymer [A]ₓ[B]_{y} or adding the block copolymer [A]ₓ[B]_{y} to water, optionally using surfactants, preferably by addition of a suitable base;
5. optional removal of solvent from the block copolymer [A]ₓ[B]_{y} dispersion (if solvent is still present from step 4.);
6. performing an emulsion polymerisation process of monomers in the presence of the block copolymer [A]ₓ[B]_{y} dispersion prepared in step 4 and or step 5 to obtain polymer P.

Alternatively after step 1 the solvent is removed by a suitable method to get a solid, which solid can be afterwards dispersed into water.

Furthermore the polymerisation process to make the block copolymer or the polymer may be carried out as either a batch, semi-batch or a continuous process. When the polymerisation process for the block copolymer is carried out in the batch mode, the reactor is typically charged with a polymerisation medium, typically an organic solvent, the control agent and monomer. To the mixture is then added the desired amount of initiator. The mixture is then heated for the required reaction time. In a batch process, the reaction may be run under pressure to avoid monomer reflux.

Furthermore after preparation of a first block, the prepared block can be purified from residual monomers and subsequently used for the polymerisation of a second monomer composition as a second block or the second monomer composition can be polymerised directly after the preparation of first block is completed. In this case at least 80 wt %, preferably at least 90 wt %, most preferred at least 95 wt % of the first block monomer composition is reacted before the second monomer composition is reacted. The second block can contain up to 20 wt % (preferably 10 wt % or less) of the first monomer composition.

A free-radical polymerisation of ethylenically unsaturated monomers to make either the block copolymer and or the polymer will require the use of a source of free radicals (i.e. an initiator) to initiate the polymerisation. Suitable free-radical-yielding initiators include inorganic peroxides such as K, Na or ammonium persulphate, hydrogen peroxide, or percarbonates; organic peroxides, such as acyl peroxides including for example benzoyl peroxide, alkyl hydroperoxides such as t-butyl hydroperoxide and cumene hydroperoxide; dialkyl peroxides such as di-t-butyl peroxide; peroxy esters such as t-butyl perbenzoate; mixtures may also be used. The peroxy compounds are in some cases advantageously used in combination with suitable reducing agents (redox systems) such as iso-ascorbic acid. Metal compounds such as Fe. EDTA (ethylene diamine tetracetic acid) may also be usefully employed as part of the redox initiator system. Azo functional initiators such as 2,2′-azobis(isobutyronitrile) (AIBN), 2,2′-azobis(2-methyl-butyronitrile) (AMBN) and 4,4′-azobis(4-cyanovaleric acid) may also be used. The amount of initiator or initiator system to use is conventional. For the preparation of the block copolymer preferably the molar amount of initiator does not exceed the molar amount of control agent that is applied. A further amount of initiator may optionally be added at the end of the polymerisation process to assist the removal of any residual ethylenically unsaturated monomers.

A chain transfer agent may be added to control the molecular weight of the polymer. Suitable chain transfer agents include mercaptans such as n-dodecylmercaptan, n-octylmercaptan, t-dodecylmercaptan, mercaptoethanol, iso-octyl thioglycolate, C₂ to C₈ mercapto carboxylic acids and esters thereof such as 3-mercaptopropionic acid and 2-mercaptopropionic acid; and halogenated hydrocarbons such as carbon tetrabromide and bromotrichloromethane. Preferably no chain transfer agent is added during the preparation of the block copolymer.

Surfactants can be utilised in order to assist in the dispersion of the block copolymer and or polymer and or in the emulsification of the monomers in water (even if self-dispersible). Suitable surfactants include but are not limited to conventional anionic, cationic and/or nonionic surfactants and mixtures thereof such as Na, K and NH₄ salts of dialkylsulphosuccinates, Na, K and NH₄ salts of alkyl sulphonic acids, Na, K and NH₄ alkyl sulphates, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups or carboxylic acid groups. Cationic surfactants include alkyl or (alk)aryl groups linked to quaternary ammonium salt groups. Nonionic surfactants include polyglycol ether compounds and preferably polyethylene oxide compounds as disclosed in “Nonionic surfactants—Physical chemistry” edited by M. J. Schick, M. Decker 1987.

An advantage of the process of the invention is that a significant reduction is possible of the amount of surfactant that is typically needed during the emulsion polymerisation process to prepare polymer P as the block copolymer can also provide the required stabilisation. The use of reduced amounts of surfactants is beneficial for the coating adhesion and for anticorrosion performance.

If monomers bearing crosslinking functional groups are present, then crosslinking may be introduced by combining the block copolymer obtained by the process of the invention with a separate crosslinker to provide either a self-crosslinking system (with a long potlife, triggered by for instance a change in temperature or pH or the evaporation of one of the ingredients in the overall system, like a solvent or water), or a two pack system.

A separate crosslinking agent is preferably selected from the group consisting of polyhydrazides (including dihydrazides such as adipic acid dihydrazide), polyamines, polyisocyanates, carbodiimides, polyaziridines, epoxies, melamine resins and mixtures thereof.

The composition obtained by the process of the invention can be in the form of a solid, a solution or as an aqueous dispersion. Most preferably the composition is used in an aqueous composition.

Furthermore the composition obtained by the process of the invention is particularly suitable for use in coating applications in which it may provide a key part of coating compositions or formulations. Such coating compositions can be pigmented or unpigmented. Such coating compositions may be applied to a variety of substrates by any conventional method including brushing, dipping, flow coating, spraying and the like. The aqueous carrier medium is removed by natural drying or accelerated drying (by applying heat) to form a coating.

The coating composition can be applied to a broad variety of metal surfaces (for example sheets or plates), including for example aluminium, duralumin, zinc, tin, copper, bronze, brass, iron, galvanized iron, and steels such as cold rolled and hot-rolled steel, aluminized steel, galvanized steel, stainless steel, and various metal-coated steels. Preferred metal surfaces are aluminium and steel and most preferably aluminium and cold rolled steel.

The composition obtained by the process of the invention may also contain conventional ingredients, some of which have been mentioned above; examples include pigments, dyes, emulsifiers, surfactants, plasticisers, thickeners, heat stabilisers, leveling agents, anti-cratering agents, fillers, sedimentation inhibitors, UV absorbers, antioxidants, drier salts, organic co-solvents, wetting agents and the like introduced at any stage of the production process or subsequently. It is possible to include an amount of antimony oxide in the emulsion to enhance the fire retardant properties.

Suitable organic co-solvents which may be added during the process or after the process during formulation steps are well known in the art and include xylene, toluene, methyl ethyl ketone, acetone, ethanol, isopropanol, ethyl acetate, butyl acetate, diethylene glycol, ethylene diglycol, butyl glycol, butyl diglycol, dipropylene glycol methyl ether, propylene glycol n-butyl ether, dipropylene glycol n-butyl ether, texanol, and 1-methyl-2-pyrrolidinone.

Suitable pigments which may be added during the process or after the process during formulation steps are well known in the art and include zinc oxide pigments, barium pigments, calcium pigments, antimony oxide pigments, zirconium pigments, chromium pigments, iron pigments, magnesium pigments and titanium dioxide pigments.

Preferably the aqueous composition comprises ≦50 wt %, more preferably from ≦40 wt % and most preferably from ≦35 wt % of organic co-solvent by weight of total polymer.

Preferably only a low concentration of aromatic solvent is added. Preferably less than 10 wt %, more preferably less than 5 wt % and most preferred less than 2 wt % of aromatic solvent by weight of total polymer is added.

The solids content of the aqueous composition is preferably within the range of from 20 to 60 wt %, and most preferably within the range of from 30 to 50 wt %.

If desired the composition obtained by the process of the invention can be used in combination with other polymer compositions which are not according to the invention.

In another embodiment there is provided an aqueous emulsion according to the invention additionally comprising a polymer Q, wherein the solids content of the block copolymer and polymer P together is ≧1 wt % and ≦35 wt % based on total solids content of block copolymer and polymer P and polymer Q together. Preferably polymer Q is an acrylic, urethane, urethane-acrylic, alkyd, alkyd-acrylic or another type of polymer.

In a preferred embodiment there is provided a blend of an aqueous polymer Q dispersion comprising an acrylic, urethane, urethane-acrylic, alkyd, alkyd-acrylic or another type of polymer Q with the aqueous emulsion of the invention. The advantage of such blending is that the overall performance properties of the aqueous polymer dispersion (coating) are retained, and additionally the aqueous emulsion of the invention provides the coating with improved wet adhesion and/or anticorrosion properties when applied onto a metal substrate.

Preferably the solids content of the aqueous emulsion prepared by the process of the invention added to the aqueous polymer Q dispersion amounts ≦35 wt % on total solids content of the blend and more preferably ≦25 wt %. Preferably the solids content of the aqueous emulsion prepared by the process of the invention added to the aqueous polymer Q dispersion amounts ≧1 wt % on total solids content of the blend and more preferably ≧5 wt %.

Preferably the polymer Q dispersion that is added to the aqueous emulsion prepared by the process of the invention is an aqueous acrylic polymer dispersion.

Preferably the particle size of the polymer Q dispersion that is blended with the aqueous emulsion prepared by the process of the invention of the invention is in the range of from 50 to 400 nm, preferably ≧100 nm. Preferably the particle size of the aqueous emulsion according to the invention is ≦100 nm.

An aspect of the invention provides a coating composition and/or polymer obtained and/or obtainable by a process of the invention

An aspect of the invention provides a coating composition obtained and/or obtainable by a process of the invention

Another aspect of the invention provides a mixture of i) block copolymer comprising at least blocks [A]ₓ[B]_{y}, and ii) polymer P; where said mixture is obtained and/or obtainable by a process of the invention

Yet another aspect of the invention provides a block copolymer-polymer comprising as components thereof i) block copolymer comprising at least blocks [A]ₓ[B]_{y} and ii) polymer P; said block copolymer-polymer obtained and/or obtainable by a process of the invention.

A further aspect of the invention provides a coating obtained and/or obtainable from a coating composition, mixture and/or block copolymer-polymer of the invention.

Another aspect of the invention provides a substrate and/or article coated with a coating of the invention.

A still other aspect of the invention provides a method of coating a substrate and/or article comprising the steps of i) applying a coating composition, mixture and/or block copolymer-polymer of the invention to the substrate and/or article; ii) drying the substrate and/or article to form a coating thereon.

A further aspect of the invention provides use of a coating composition, mixture, block copolymer-polymer, substrate and/or article of the invention to coat a substrate and/or article.

A yet other aspect of the invention provides for a coated substrate and/or article obtained and/or obtainable by the method of coating of the invention.

A further aspect of the invention provides use of a coating composition, mixture, block copolymer-polymer, substrate and/or article of the invention in at least one of the applications described herein.

A still yet other aspect of the invention provides a method of manufacture of a coating composition, mixture, block copolymer-polymer, substrate and/or article of the invention for the purpose being used in at least one of the applications described herein.

The terms ‘effective’, ‘acceptable’, ‘active’ and/or ‘suitable’ (for example with reference to any process, use, method, application, preparation, product, material, formulation, compound, monomer, block copolymer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Many other variations embodiments of the invention will be apparent to those skilled in the art and such variations are contemplated within the broad scope of the present invention.

Further aspects of the invention and preferred features thereof are given in the claims herein.

The present invention is now illustrated by reference to the following examples. Unless otherwise specified, all parts, percentages and ratios are on a weight basis.

### Test Descriptions

### Dry Adhesion to Cold Rolled Steel (Q-Panel)

The level of dry adhesion to an untreated cold rolled steel test panel (Q-panel) was determined using a cross-cut test (“Gitterschnitt” (Gt) test in accordance with ASTM D 3002/D 3359 and DIN EN ISO 2409). A cross-cut was made onto the dried coated cold rolled steel panels using a cross-cut knife (Byk-5120). A self adhesive tape (Sellotape™ 25 mm from Henkel Consumer Adhesives) was applied under uniform pressure onto the coated substrate, covering the cross-cut, where after the tape was torn off in a single movement. The degree of dry adhesion of the coating onto the metal substrate was then classified with a scale from 0 to 5 (according ISO Class 0-5 (Gt)) by determining the amount of coating that is detached or flaked partly or wholly along the edges of the cuts, where 0 means that the cross-cut area is not affected (excellent adhesion); 1 means that the affected cross-cut area is not significantly greater than 5%; 2 means that the affected cross-cut area is significantly greater than 5%, but not significantly greater than 15%; 3 means that the affected cross-cut area is significantly greater than 15%, but not significantly greater than 35%; 4 means that the affected cross-cut area is significantly greater than 35%, but not significantly greater than 65%; 5 means any degree of flaking that cannot even be classified by classification 4 (very poor adhesion).

### Wet Adhesion to Cold Rolled Steel (Q-Panel)

To determine the level of wet adhesion to an untreated cold rolled steel test panel (Q-panel) a large droplet of demineralised water was placed onto an area of the coated substrate. After 2 hours at about 20 (±3° C.) the water droplet was carefully removed with a tissue and the coating was left for another 2 hours. The level of wet adhesion was then determined according the cross-cut test method used for determining the dry adhesion, where the cross-cut was made onto the coated area that was exposed to the water droplet.

In the examples, the following abbreviations and terms are specified:

AA=acrylic acid
AAEM=acetoacetoxyethyl methacrylate
APS=ammonium persulfate
BA=butyl acrylate
BMA=butyl methacrylate
DP=average degree of polymerisation
PAM200=a phosphate functional methacrylate monomer (that available commercially from Rhodia under the trade name Sipomer PAM-200);
iBOA=isobornyl acrylate
Sty=styrene
xanthate 1=O-ethyl-S-(1-methoxycarbonyl)ethyl dithiocarbonate (available commercially from Rhodia under the trade name (Rhodixan A1, provided by Rhodia)

An overview of the Examples and the Comparatives is given in Table 1 below.

TABLE 1

| | | Polymer P | Block |
|---|---|---|---|
| | [A]ₓ-[B]_{y} block copolymer | (wt % on total | copolymer wt % |
| Experiment | (DP) | monomers) | of total polymer |
| Example 1 | 1 = AA-BA/PAM200 | Sty/BMA/BA(35/52/13) | 5% |
| | (20-64/16) | | |
| Example 2 | 2 = AA-BA/PAM200 | Sty/BMA/BA | 10% |
| | (20-72/8) | (35/52/13) | |
| Example 3 | 3 = AA-BA/ | Sty/BMA/BA | 10% |
| | iBOA/PAM200 | (35/52/13) | |
| | (20-50/40/10) | | |
| Example 4 | 4 = AA-BA/AAEM | Sty/BMA/BA | 10% |
| | (20-100/20) | (35/52/13) | |
| Example 5 | 5 = AA-iBOA | Sty/BMA/BA | 5% |
| | (20-50) | (35/52/13) | |
| Comparative 1 | 6 = AA-BA | Sty/BMA/BA | 10% |
| | (20-100) | (35/52/13) | |
| Comparative 2 | None | Sty/BMA/BA/AA/AAEM | — |
| | | (33.9/50.3/12.6/1.0/2.2) | |
| Comparative 3 | None | Sty/BMA/BA/AA/iBOA | — |
| | | (32.0/47.5/11.8/1.0/7.7) | |

### Block Copolymer 1

Synthesis of a [A]ₓ[B]_{y} Diblock Copolymer where Block [A] is Based on AA and x=20 and Block [B] is Based on BA and PAM200 with y=80 (DP BA=64; DP PAM200=16)

### Block [A]

170 gram of ethanol and 28.3 gram (137 mmol) of xanthate 1 were added to a 1 L three-necked glass flask equipped with condenser cooler, temperature measuring probe and mechanical stirring device. The reaction mixture was degassed by purging with nitrogen at room temperature for 15 minutes while stirring. The temperature was raised to 75° C. and 10 wt % of a monomer feed mixture of 197 gram (2.73 mol) of AA and 228 gram of ethanol was added to the reaction mixture. Then a mixture of 2.3 gram (approximately 6 mmol) of 4,4′-azobis(4-cyanovaleric acid) (Aldrich, 75+%) and 25 gram of ethanol was added. After 15 minutes at 70° C. the gradual addition was started of the remaining 90 wt % of the AA/ethanol mixture. The addition lasted 4 hours under a weak nitrogen stream and at a controlled temperature of 70° C., after which the mixture was kept for 6 hours at 70° C. The reaction mixture was then cooled to 20° C. and a sample was withdrawn for further analysis. The conversion of AA as determined with gas chromatography was found to be 96% and the solids level was experimentally determined at 37.5%. GPC analysis of the final product (using THF as solvent and calibration on polystyrene standards) resulted in the following values: Mn=1905 g/mol, PDI (=Mw/Mn)=1.30.

### Block [B]

80.0 gram of the block [A] reaction mixture, corresponding to approximately 18.2 mmol of precursor block [A] based on a solids level of 37.5% and a theoretical molecular weight of 1650 g/mol, was added together with 80 gram of ethanol to a 1 L three-necked glass flask equipped with condenser cooler, temperature measuring probe and mechanical stirring device. The reaction mixture was degassed by purging with nitrogen at room temperature for 15 minutes while stirring. The temperature was raised to 70° C. and 10 wt % of a monomer feed mixture of 150.0 gram (1.17 mol) of BA, 146.0 gram (approximately 0.3 mol) of PAM200, and 175 gram of ethanol was added to the reaction mixture. Then a mixture of 1.0 gram (approximately 2.7 mmol) of 4,4′-azobis(4-cyanovaleric acid) (Aldrich, 75+%) and 20 gram of ethanol was added to the reaction mixture. After 15 minutes at 70° C. the gradual addition was started of the remaining 90 wt % of the BA/PAM200/ethanol mixture. The addition lasted approximately 4 hours under a weak nitrogen stream and at a controlled temperature of 70° C. Extra ethanol (about 75 gram) was then added to reduce the viscosity of the reaction mixture, after which the mixture was kept for 6 hours at 70° C. The reaction mixture was then cooled to 20° C. and a sample was withdrawn for further analysis. The conversion of BA as determined with gas chromatography was found to be 95%. The theoretical final solids level was about 45%. GPC analysis of the final product (using THF as solvent and calibration on polystyrene standards) resulted in the following values: Mn=2625 g/mol, PDI (=Mw/Mn)=3.09.

### Block Copolymer 2

Synthesis of a [A]ₓ[B]_{y} Diblock Copolymer where Block [A] is Based on AA and x=20 and Block [B] is Based on BA and PAM200 with y=80 (DP BA=72; DP PAM200=8)

The preparation of Block copolymer 2 was performed using the same recipe and procedure as applied for Block copolymer 1, but now the monomer reaction mixture for block [B] consisted of 168.0 gram (1.31 mol) of BA, 73.0 gram (approximately 0.15 mol) of PAM200, and 120 gram of ethanol. Analysis of the final product resulted in 95% conversion of BA as determined with gas chromatography, and a theoretical final solids level of 45%. GPC analysis of the final product (using THF as solvent and calibration on polystyrene standards) resulted in the following values: Mn=4070 g/mol, PDI (=Mw/Mn)=2.64.

### Block Copolymer 3

Synthesis of a [A]ₓ[B]_{y} Diblock Copolymer where Block [A] is Based on AA and x=20 and Block [B] is Based on BA, iBOA and PAM200 with y=100 (DP BA=50; DP iBOA=40; DP PAM200=10)

The block [A] reaction mixture was prepared according a similar procedure as applied for Block copolymer 1 (data for block [A] from GPC analysis: Mn=2190 g/mol, PDI=1.25). For the preparation of block [B] of Block copolymer 3, 150.0 gram of the block [A] reaction mixture, corresponding to approximately 35 mmol of precursor block [A] at a solids level of 38.1% and a theoretical molecular weight of 1650 g/mol, and 200.0 gram methyl ethyl ketone (MEK) was added to a 2 L three-necked glass flask equipped with condenser cooler, temperature measuring probe and mechanical stirring device. The reaction mixture was degassed by purging with nitrogen at room temperature for 15 minutes while stirring. The temperature was raised to 75° C. and 10 wt % of a monomer feed mixture of 222.0 gram (1.73 mol) of BA, 289.0 gram (approximately 1.39 mol) of iBOA, 173.0 gram (approximately 0.35 mol) of PAM200, and 430 gram of MEK was added to the reaction mixture. Then a mixture of 3.0 gram (approximately 8 mmol) of 4,4′-azobis(4-cyanovaleric acid) (Aldrich, 75+%) and 10 gram of ethanol was added to the reaction mixture. After 15 minutes at 75° C. the gradual addition was started of the remaining 90 wt % of the BA/iBOA/PAM200/MEK mixture. The addition lasted approximately 4 hours under a weak nitrogen stream and at a controlled temperature of 75° C. At the end of the feed a mixture of 1.0 gram of 4,4′-azobis(4-cyanovaleric acid) and 10 gram MEK was added and the reaction mixture was kept for 5 hours at 75° C. The reaction mixture was then cooled to 20° C. and a sample was withdrawn for further analysis. The conversion of BA as determined with gas chromatography was found to be 95%. The theoretical final solids level was about 50%. GPC analysis of the final product (using THF as solvent and calibration on polystyrene standards) resulted in the following values: Mn=5480 g/mol, PDI (=Mw/Mn)=2.44.

### Block Copolymer 4

Synthesis of a [A]ₓ[B]_{y} Diblock Copolymer where Block [A] is Based on AA and x=20 and Block [B] is Based on BA and AAEM with y=120 (DP BA=100; DP AAEM=20)

The block [A] reaction mixture used for the preparation of Block copolymer 3 was also used to prepared Block copolymer 4. For the preparation of block [B] of Block copolymer 4, 86.0 gram of the block [A] reaction mixture, corresponding to approximately 20 mmol of precursor block [A] at a solids level of 38.1% and a theoretical molecular weight of 1650 g/mol, and 170.0 gram MEK was added to a 1 L three-necked glass flask equipped with condenser cooler, temperature measuring probe and mechanical stirring device. The reaction mixture was degassed by purging with nitrogen at room temperature for 15 minutes while stirring. The temperature was raised to 75° C. and 10 wt % of a monomer feed mixture of 256.5 gram (2.0 mol) of BA, 85.5 gram (0.40 mol) of AAEM, and 134.0 gram of MEK was added to the reaction mixture. Then a mixture of 2.1 gram (approximately 6 mmol) of 4,4′-azobis(4-cyanovaleric acid) (Aldrich, 75+%) and 20 gram of ethanol was added to the reaction mixture. After 15 minutes at 70° C. the gradual addition was started of the remaining 90 wt % of the BA/AAEM/MEK mixture. The addition lasted approximately 4 hours under a weak nitrogen stream and at a controlled temperature of 70° C. The reaction mixture was then kept for 4 hours at 70° C. The reaction mixture was then cooled to 20° C. and a sample was withdrawn for further analysis. The conversion of BA as determined with gas chromatography was found to be 96%. The theoretical final solids level was about 50%. GPC analysis of the final product (using THF as solvent and calibration on polystyrene standards) resulted in the following values: Mn=10440 g/mol, PDI (=Mw/Mn)=2.13.

### Block Copolymer 5

Synthesis of a [A]ₓ[B]_{y} Diblock Copolymer where Block [A] is Based on AA and x=20 and Block [B] is Based on iBOA with y=50

Block copolymer 5 was prepared according a similar recipe and the same procedure as used for Block copolymer 4, only now 132.5 gram of the block [A] reaction mixture, corresponding to approximately 30 mmol of precursor block [A] at a solids level of 38.1% and a theoretical molecular weight of 1650 g/mol, and 45.0 gram ethanol was used. The monomer feed mixture consisted of 317.0 gram (1.5 mol) of iBOA and 200.0 gram of MEK, and a mixture of 2.25 gram (approximately 6 mmol) of 4,4′-azobis(4-cyanovaleric acid) and 20 gram of ethanol was applied. Following the same procedure as for block copolymer 4, the conversion of iBOA at the end of the reaction as determined with gas chromatography was found to be 96%. The theoretical final solids level was 50%. GPC analysis of the final product (using THF as solvent and calibration on polystyrene standards) resulted in the following values: Mn=4870 g/mol, PDI=2.12.

### Block Copolymer 6

Synthesis of a [A]ₓ[B]_{y} Diblock Copolymer where Block [A] is Based on AA and x=20 and Block [B] is Based on BA and y=100

The block [A] reaction mixture was prepared according a similar procedure as described for Block copolymer 1 (data for block [A] from GPC analysis: Mn=1441 g/mol, PDI (=Mw/Mn)=1.20). For the preparation of block [B] of Block copolymer 6, 90 gram of the block [A] reaction mixture, corresponding to approximately 18 mmol of precursor block [A] based on a solids level of 33% and a theoretical molecular weight of 1650 g/mol, was added to a 1 L three-necked glass flask equipped with stirrer, condenser cooler, temperature measuring probe. The reaction mixture was purged with nitrogen at room temperature for 15 minutes while stirring. The temperature was raised to 70° C. and 5 wt % of a monomer feed mixture of 230 gram (1.8 mol) of BA and 200 gram of ethanol was added to the reaction mixture. Then 0.7 gram (3.6 mmol) of 2,2′-azobis(2-methylbutanenitril) (Vazo 67, DuPont) was added to the reaction mixture. After 15 minutes at 70° C. the gradual addition was started of the remaining 95 wt % of the BA/ethanol mixture. The addition lasted 6 hours under a weak nitrogen stream and at a controlled temperature of 70° C., after which the mixture was kept for an additional 2 hours at 70° C. Final conversion of BA as determined with gas chromatography was found to be 96%. The final solids level was experimentally determined at 49.1%. GPC analysis of the final product (using THF as solvent and calibration on polystyrene standards) resulted in the following values: Mn=8090 g/mol, PDI=1.94.

### Preparation of an Aqueous Dispersion of Block Copolymer 1

26 gram of triethylamine was added to 577 gram of Block copolymer 1, followed by the slow addition of 1038 gram of demineralised water at 20° C. whilst stirring. A clear aqueous solution was obtained of which the pH was further adjusted from 4.5 to 8 by addition of 35 gram of triethylamine. After removal of residual solvent from the solution under reduced pressure and extra addition of demineralised water the final solids was experimentally determined at 24.2%.

### Preparation of an Aqueous Dispersion of Block Copolymer 2

29 gram of triethylamine was added to 537 gram of Block copolymer 2, followed by the slow addition of 967 gram of demineralised water at 20° C. whilst stirring. A clear aqueous solution was obtained of which the pH was further adjusted from 6 to 8 by addition of 9 gram of triethylamine. After removal of residual solvent from the solution under reduced pressure and extra addition of demineralised water the final solids was experimentally determined at 23.2%.

### Preparation of an Aqueous Dispersion of Block Copolymer 3

21 gram of ammonia (25% in water) was added to 500 gram of Block copolymer 3 at 70° C., followed by the slow addition of 778 gram of demineralised water whilst stirring. The pH was then further adjusted to 7.5 with 28 gram of ammonia (25%), and the residual solvent was removed from the obtained dispersion under reduced pressure. The final solids was experimentally determined at 25.3% and the particle size of the stable aqueous dispersion as determined with light scattering was 323 nm.

### Preparation of an Aqueous Dispersion of Block Copolymer 4

17 gram of triethylamine was added to 360 gram of Block copolymer 4, followed by the slow addition of 535 gram of demineralised water at 20° C. whilst stirring. After removal of residual solvent under reduced pressure the final pH and solids was determined at 7.7 and 26.1%, respectively. The particle size of the stable aqueous dispersion as determined with light scattering was 52 nm.

### Preparation of an Aqueous Dispersion of Block Copolymer 5

74.4 gram of triethylamine was added to 557 gram of Block copolymer 4 at 70° C., followed by the slow addition of 979 gram of demineralised water whilst stirring. After removal of residual solvent under reduced pressure the final pH and solids was determined at 8.8 and 26.1%, respectively. The particle size of the stable aqueous dispersion as determined with light scattering was 41 nm.

### Preparation of an Aqueous Dispersion of Block Copolymer 6

25 gram of triethylamine was added to 480 gram of Block copolymer 6, followed by the slow addition of 720 gram of demineralised water at 20° C. whilst stirring. A stable aqueous dispersion was obtained of which the pH was further adjusted to 8.5 by addition of triethylamine. After removal of residual ethanol from the dispersion under reduced pressure and extra addition of demineralised water the final solids was experimentally determined at 25.0%. The particle size of the dispersion as determined with light scattering was 40 nm.

### EXAMPLE 1

### Synthesis of a Sty/BMA/BA Emulsion Polymer Based on Block Copolymer 1

350 gram of demineralised water and 62.3 gram of the aqueous dispersion of Block copolymer 1 prepared above (24.2% in water) were added to a 1 L three-necked glass flask equipped with stirrer, condenser cooler and temperature measuring probe. The reaction mixture was heated while stirring to 75° C. under nitrogen atmosphere. Then a mixture of 2.6 gram Sty, 3.9 gram BMA and 1.0 gram BA was added. After 10 minutes mixing at 75° C. an initiator mixture of 0.27 gram APS and 4.8 gram demineralised water, set at pH=8 with triethylamine, was added. The reaction mixture was then heated to 85° C. After 15 minutes at 85° C. the gradual addition was started of an initiator feed mixture of 0.63 gram APS and 62.7 gram of demineralised water, set at pH=8 with triethylamine, and of a pre-emulsified monomer feed mixture of 121.1 gram demineralised water, 1.5 gram Lankropol KO2 (60 wt % in water, available from Akzo) 102.9 gram Sty, 152.9 gram BMA and 38.2 gram BA. Both mixtures were added as parallel feeds to the reaction mixture over a time period of 2.5 hours and at a controlled reaction temperature of 85° C. During the reaction the pH of the reaction mixture was kept above 7.0. At the end of the monomer and initiator feed the reaction mixture was kept for 30 minutes at 85° C. A post reaction with tert-butyl hydroperoxide and isoascorbic acid was performed to react any residual monomer. The resultant emulsion was then cooled to room temperature.

Example 2 and Comparative example 1 were prepared according a similar recipe and procedure as applied for Example 1, where the type and amount of block copolymer was varied (see Table 1).

### EXAMPLE 3

### Synthesis of a Sty/BMA/BA Emulsion Polymer Based on Block Copolymer 3

248.5 gram of demineralised water and 100 gram of the aqueous dispersion of Block copolymer 3 prepared above (25.3% in water) were added to a 1 L three-necked glass flask equipped with stirrer, condenser cooler and temperature measuring probe. The reaction mixture was heated while stirring to 82° C. under nitrogen atmosphere. Then 10 wt % of a pre-emulsified monomer feed mixture consisting of 108 gram demineralised water, 0.84 gram Lankropol KO2 (60 wt % in water, available from Akzo), 88.4 gram Sty, 131.3 gram BMA and 32.8 gram BA was added. After 30 minutes mixing at 75° C. an initiator mixture of 0.23 gram APS and 4.3 gram demineralised water, set at pH=8 with triethylamine, was added. After 30 minutes mixing at 75° C. an initiator mixture of 0.23 gram APS and 4.3 gram demineralised water, set at pH=8 with triethylamine, was added. The reaction mixture was then heated to 88° C. After 15 minutes at 85° C. the gradual addition was started of an initiator feed mixture of 0.53 gram APS and 52.5 gram of demineralised water, set at pH=8 with triethylamine, and the remaining 90 wt % of the pre-emulsified monomer feed mixture. Both mixtures were added as parallel feeds to the reaction mixture over a time period of 2 hours and at a controlled reaction temperature of 88° C. During the reaction the pH of the reaction mixture was kept above 7.0. At the end of the monomer and initiator feed the reaction mixture was kept for 30 minutes at 88° C. A post reaction with tert-butyl hydroperoxide and isoascorbic acid was performed to react any residual monomer. The resultant emulsion was then cooled to 20° C.

### EXAMPLE 4

### Synthesis of a Surfactant-Free Sty/BMA/BA Emulsion Polymer Based on Block Copolymer 4

290.5 gram of demineralised water and 110.8 gram of the aqueous dispersion of Block copolymer 4 prepared above (26.1% in water) were added to a 1 L three-necked glass flask equipped with stirrer, condenser cooler and temperature measuring probe. The reaction mixture was heated while stirring to 82° C. under nitrogen atmosphere. Then 20 wt % of a monomer feed mixture consisting of 101.2 gram Sty, 150.4 gram BMA and 37.6 gram BA was added. After 30 minutes mixing at 70° C. an initiator mixture of 0.26 gram APS and 4.9 gram demineralised water, set at pH=8 with ammonia (25%), was added. Then after 10 minutes the reaction mixture was heated to 88° C. After 15 minutes at 88° C. the gradual addition was started of an initiator feed mixture of 0.61 gram APS and 60.1 gram of demineralised water, set at pH=8 with ammonia (25%), and the remaining 80 wt % of the monomer feed mixture. Both mixtures were added as parallel feeds to the reaction mixture over a time period of 2 hours and at a controlled reaction temperature of 88° C. During the reaction the pH of the reaction mixture was kept above 7.0. At the end of the monomer and initiator feed the reaction mixture was kept for 30 minutes at 88° C. A post reaction with tert-butyl hydroperoxide and isoascorbic acid was performed to react any residual monomer. The resultant emulsion was then cooled to 20° C.

### COMPARATIVE EXAMPLE 2

### Synthesis of a Sty/BMA/BA/AA/AAEM Emulsion Polymer

653 gram of demineralised water and 8.2 gram of Lankropol KO2 (60 wt % in water) were added to a 2 L three-necked glass flask equipped with stirrer, condenser cooler and temperature measuring probe. The reaction mixture was heated while stirring to 80° C. under nitrogen atmosphere. Then 10 wt % of a pre-emulsified monomer feed mixture consisting of in total 235 gram demineralised water, 15.3 gram Lankropol KO2 (60% in water), 239.4 gram Sty, 355.2 gram BMA, 89.0 gram BA, 7.1 gram AA, 15.5 gram AAEM and 1.4 gram iso-octyl thioglycolate was added. The reaction mixture was then heated to 75° C. After 10 minutes at 75° C. 20 wt % of an initiator mixture of 2.82 gram APS and 91.3 gram demineralised water was added. Then after 5 minutes the reaction mixture was heated to 85° C. After 20 minutes at 85° C. the gradual addition was started of the remaining 80 wt % of the initiator feed and 90 wt % of the monomer feed. Both mixtures were added as parallel feeds to the reaction mixture over a time period of 2 hours and at a controlled reaction temperature of 85° C. At the end of the monomer and initiator feed the reaction mixture was kept for 30 minutes at 85° C. A post reaction with tert-butyl hydroperoxide and isoascorbic acid was performed to react any residual monomer. The resultant emulsion was then cooled to room temperature and the pH of the latex was adjusted to 8.0 by addition of ammonia.

Comparative example 3 was prepared according the same recipe and procedure as applied for Comparative example 2, but now AAEM was replaced with iBOA (7.7% on monomers) while the weight ratio of Sty/BMA/BA was maintained.

The properties of the final prepared acrylic dispersions are given in Table 2. Final free monomer levels were all below 500 ppm. All latices were processed with little or no fouling and/or sediment formation. Molecular weights were determined with GPC using THF as solvent and calibration on polystyrene standards.

TABEL 2

| | | | | Final | Mn | Mw |
|---|---|---|---|---|---|---|
| | | | Viscosity | particle | (GPC) | (GPC) |
| | Solids¹⁾ | pH | (Brookfield) | size (DLS) | [kg/ | [kg/ |
| Experiment | [%] | [-] | [mPa · s] | [nm] | mol] | mol] |
| Example 1 | 33.8 | 7.6 | <10 | 231 | 43 | 276 |
| Example 2 | 40.0 | 7.6 | 68 | 290 | 31 | 198 |
| Example 3 | 35.2 | 7.7 | 15 | 146 | 57 | 257 |
| Example 4 | 39.7 | 8.2 | 13 | 114 | 52 | 228 |
| Example 5 | 34.2 | 7.8 | 10 | 95 | 65 | 314 |
| Comparative | 36.6 | 7.1 | 85 | 79 | 49 | 157 |
| 1 | | | | | | |
| Comparative | 40.1 | 7.6 | 16 | 102 | 36 | 141 |
| 2 | | | | | | |
| Comparative | 40.7 | 7.5 | 18 | 101 | 31 | 114 |
| 3 | | | | | | |

Notes
¹⁾gravimetrically determined

Prior to testing the acrylic dispersions of Examples 1 and 2 and Comparative example 1 were formulated with 28.5% of a mixture of demineralised water/butyl glycol (43/57 weight ratio set to pH 8 with ammonia), 2.5% of wetting agent (Fluowet SB, available from Clariant, 1% in water) and 1.2% of flash rust inhibitor (Nalzin FA-179, available from Elementis Specialties). Examples 3, 4 and 5 and Comparative examples 2 and 3 were all formulated with 11% of a mixture of demineralised water/butyl glycol/texanol (5/4.5/1.5 parts by weight, set to pH 8 with ammonia), 0.2% of wetting agent (Byk 346), and 0.4% of Nalzin FA-179.

Films of the formulated dispersions were casted onto untreated cold rolled steel test panels (Q-panel) at 150 micron wet and dried for 2 to 4 hours at room temperature. The films were then dried in an oven at 50° C. for a period of 16 hours. The obtained dry films were then examined for dry and wet adhesion (see test descriptions). Test results are given in Table 3.

TABLE 3

| | Dry Adhesion | Wet Adhesion |
|---|---|---|
| | (0 to 5; | (0 to 5; |
| | 0 is excellent | 0 is excellent |
| Experiment | 5 is poor) | 5 is poor) |
| Example 1 | 0 | 2-3 |
| Example 2 | 0 | 1-2 |
| Example 3 | 0 | 0 |
| Example 4 | 0 | 2-3 |
| Example 5 | 0 | 0 |
| Comparative 1 | 5 | 5 |
| Comparative 2 | 2 | 5 |
| Comparative 3 | 4-5 | 5 |

As shown from the results in Table 3 the compositions of the invention (Examples 1 to 5) all have better adhesion to cold rolled steel, and in particular much better wet adhesion than the Comparative examples.

1. An aqueous, metal, coating composition comprising a block copolymer and an emulsion polymer P; wherein the block copolymer comprises at least blocks [A]ₓ[B]_{y}, where at least block [A] is obtained and/or obtainable by a controlled radical polymerisation of at least one ethylenically unsaturated monomer via a reversible addition-fragmentation chain transfer (RAFT) mechanism in solution in the presence of a control agent and a source of free radicals; wherein
(a) block [A] is obtained and/or obtainable from monomers comprising
i) 0 to 80 mol % of ethylenically unsaturated monomers bearing metal adhesion promoting functional groups;
ii) 0 to 100 mol % of ethylenically unsaturated monomers bearing water-dispersing functional groups;
iii) 0 to 70 mol % of ethylenically unsaturated monomers selected from the group consisting of: C₁ to C₃₀ hydrocarbo (meth)acrylate monomers, styrenic monomers and mixtures thereof;
iv) 0 to 35 mol % of ethylenically unsaturated monomer different from i), ii)+iii);
where the amount of at least one of i), ii), iii)+iv) is >0 mol %;
block [A] has a Hansch parameter <1.5; and
block [A] has an average degree of polymerisation x, where x is an integer from 3 to 80;
(b) block [B] is obtained and/or obtainable from monomers comprising:
i) 0 to 50 mol % of ethylenically unsaturated monomes bearing metal adhesion promoting functional groups;
ii) 0 to 15 mol % of ethylenically unsaturated monomers bearing water-dispersing functional groups;
iii) 20 to 100 mol % of ethylenically unsaturated monomers selected from the group consisting of: C₁ to C₃₀ hydrocarbo (meth)acrylate monomers, styrenic monomers and mixtures thereof;
iv) 0 to 35 mol % of ethylenically unsaturated monomers units different from those from i), ii)+iii);
where block [B] has a Hansch parameter ≧1.5; and
block [B] has an average degree of polymerisation y, where y is an integer ≧10, where y>x; and
(c) wherein polymer P is obtained and/or obtainable in the presence of the block copolymer [A][B] by an emulsion polymerisation process, and polymer P is obtained and/or obtainable from monomers comprising:
i) 0 to 5% by weight of ethylenically unsaturated monomers bearing metal adhesion promoting functional groups;
ii) 0 to 15% by weight of ethylenically unsaturated monomers bearing water-dispersing functional groups;
iii) 50 to 100% by weight of ethylenically unsaturated monomers selected from the group consisting of: C₁ to C₃₀ hydrocarbo (meth)acrylate monomers, styrenic monomers and mixtures thereof;
iv) 0 to 35% by weight of ethylenically unsaturated monomers different from those from i), ii)+iii).

2. A process for preparing an aqueous, metal, coating composition comprising a block copolymer and an emulsion polymer P; wherein the block copolymer comprising at least blocks [A]ₓ[B]_{y}, where the process comprises the steps of:
(a) obtaining at least block [A] by a controlled radical polymerisation of at least one ethylenically unsaturated monomer via a reversible addition-fragmentation chain transfer (RAFT) mechanism in solution in the presence of a control agent and a source of free radicals;
where block [A] is obtained by polymerising monomers comprising
i) 0 to 80 mol % of ethylenically unsaturated monomers bearing metal adhesion promoting functional groups;
ii) 0 to 100 mol % of ethylenically unsaturated monomers bearing water-dispersing functional groups;
iii) 0 to 70 mol % of ethylenically unsaturated monomers selected from the group consisting of: C₁ to C₃₀ hydrocarbo (meth)acrylate monomers, styrenic monomers and mixtures thereof;
iv) 0 to 35 mol % of ethylenically unsaturated monomer different from i), ii)+iii);
where the amount of at least one of i), ii), iii)+iv) is >0 mol %;
block [A] has a Hansch parameter <1.5; and
block [A] has an average degree of polymerisation x, where x is an integer from 3 to 80;
b) obtaining at least block [B] by polymerising monomers comprising:
i) 0 to 50 mol % of ethylenically unsaturated monomes bearing metal adhesion promoting functional groups;
ii) 0 to 15 mol % of ethylenically unsaturated monomers bearing water-dispersing functional groups;
iii) 20 to 100 mol % of ethylenically unsaturated monomers selected from the group consisting of: C₁ to C₃₀ hydrocarbo (meth)acrylate monomers, styrenic monomers and mixtures thereof;
iv) 0 to 35 mol % of ethylenically unsaturated monomers units different from those from i), ii)+iii);
where block [B] has a Hansch parameter ≧1.5;
block [B] has an average degree of polymerisation y, where y is an integer ≧10, where y>x; and
c) obtaining polymer P in the presence of the block copolymer [A][B] by emulsion polymerisation of:
i) 0 to 5% by weight of ethylenically unsaturated monomers bearing metal adhesion promoting functional groups;
ii) 0 to 15% by weight of ethylenically unsaturated monomers bearing water-dispersing functional groups;
iii) 50 to 100% by weight of ethylenically unsaturated monomers selected from the group consisting of: C₁ to C₃₀ hydrocarbo (meth)acrylate monomers, styrenic monomers and mixtures thereof;
iv) 0 to 35% by weight of ethylenically unsaturated monomers different from those from i), ii)+iii);

3. A process as claimed in claim 2, in which the amount of i) in block [A]+i) in block [B] add up to >5 mol %.

4. A process as claimed in claim 2, in which component (ii) of block [A] comprises >50% by weight of a carboxylic acid functional ethylenically unsaturated monomer.

5. A process as claimed in claim 2, in which component (iii) of block [B] comprises >70% by weight of a hydrophobic ethylenically unsaturated monomer selected from the group consisting of: C₁ to C₃₀ hydrocarbo (meth)acrylate monomers and stryrenic monomers.

6. A process as claimed in claim 2, in which block [B] has a calculated Tg of at least 40° C.

7. A process as claimed in claim 2, where the amount of i) in block [A]+i) in block [B] add up to >5 mol %.

8. A process according to claim 2, where block [B] is obtained by a controlled radical polymerisation of at least one ethylenically unsaturated monomer via a reversible addition-fragmentation chain transfer mechanism in solution in the presence of a control agent and a source of free radicals.

9. A process according to claim 2, wherein the control agent is selected from the group consisting of dithioesters, thioethers-thiones, trithiocarbonates, dithiocarbamates, xanthates and mixtures thereof.

10. A process according to claim 2, wherein the ethylenically unsaturated monomer units bearing metal adhesion promoting functional groups are selected from the group consisting of monomers with phosphate functionality; monomers with phosphonate functionality; monomers with phosphonic acid functionality; monomers with sulphonic acid functionality; monomers with (meth)acryloylpropionic acid functionality; monomers with anhydride functionality; monomers with acetoacetoxy functionality; monomers with amine functionality; monomers with amide functionality; monomers with silane functionality; monomers with ureido functionality; and mixtures thereof.

11. A process according to claim 2, wherein the difference in Tg between block [A] and block [B] is ≧20° C.

12. A process as claimed in claim 2, where component i) (ethylenically unsaturated monomer units bearing metal adhesion promoting functional groups) is absent from block [A], block [B] and polymer P.

13. An aqueous, metal coating composition comprising a coating composition obtained and/or obtainable according the process claimed in claim 2.

14. A method of coating a surface comprising the steps of:
a) applying a composition as claimed in claim 1 to a surface;
b) optionally drying the composition thereon.

15. A method of coating as claimed in claim 16, where the surface comprises metal.

16. Use of a coating composition as claimed in claim 1 to coat a surface.

17. Use as claimed in claim 16, where the surface comprises metal.

18. A metal coating composition comprising a composition as claimed in claim 1.

19. A method of manufacturing a composition as claimed in claim 1, for the purpose of coating surfaces comprising metal.

20. A substrate coated with a composition as claimed in claim 1, where the substrate surface, before coating, comprises metal.

21. An article comprising a coated substrate as claimed in claim 20.
